(19) United States
(12) Patent Application Publication
(10) Pub. No.: US 2026/0059620 A1
(43) Pub. Date: Feb. 26, 2026

(54) RADIO WAVE EMITTING DEVICE

(71) Applicant: Panasonic Intellectual Property Management Co., Ltd., Osaka (JP)

(72) Inventors: MIKIO FUKUI, Nara (JP); SHINJI TAKANO, Gifu (JP); TAKASHI UNO, Shiga (JP)

(21) Appl. No.: 19/109,131

(22) PCT Filed: Sep. 6, 2023
(86) PCT No.: PCT/JP2023/032450

§ 371 Date: Mar. 6, 2025

(30) Foreign Application Priority Data
Sep. 7, 2022 (JP) 2022-142488

(51) Int. Cl. H05B 6/72

(52) U.S. Cl. CPC H05B 6/72

(57) ABSTRACT

In a radio wave emitting device of the present disclosure, the controller switches an operation of the device from a normal operation to a protection operation when, during execution of the normal operation, protection is necessary for at least one of signal amplifiers based on one or both of temperature measurement values and reflected-wave power measurement values. The normal operation includes setting an electric power target value for a radio wave to a normal target value for radio wave emitters. The protection operation includes setting the electric power target value for the radio wave to a protection target value for radio wave emitters. For one or both of a protection target radio wave emitter and a radio wave emitter other than the protection target radio wave emitter, the protection target value is lower than the normal target value. The protection target value is set so that a power consumption distribution in a cavity when executing the protection operation is closer to that when executing the normal operation than that when only the electric power target value of the protection target radio wave emitter is set to the protection target value.

### BACKGROUND

### Technical Field

The present disclosure relates to a radio wave emitting device.

### Background Art

PTL 1 discloses a microwave processing apparatus (radio wave emitting device). The microwave processing apparatus disclosed in PTL 1 includes a heating chamber accommodating a heating-target object, an oscillator, a power unit, a detector, a power feeder, and a controller.

The power unit amplifies output signals from the oscillator and outputs the amplified electric power. The detector detects, among the output electric power from the power unit, the electric power of reflected waves, which are the microwaves that flow back toward the power unit, and the electric power of traveling waves, which are the microwaves that are output from the power unit and travel toward the heating chamber.

The power feeder emits the traveling waves from the detector into the heating chamber. The controller controls the frequency and level of the output signal from the oscillator according to the reflected waves.

The controller provides a pre-search period before the heating-target object is heated, and a main heating period in which full-scale heating to the heating-target object is performed. In the pre-search period, the controller causes the oscillator to output a low-level signal while periodically and repeatedly changing the frequency over a predetermined frequency band. The controller determines an optimum oscillation frequency based on the reflected waves.

In the main heating period, the controller causes the oscillator to output signals having the optimum oscillation frequency and frequencies adjacent thereto, to carry out the main heating to the heating-target object. When the reflected waves increase as the heating to the heating-target object advances in the main heating period, the controller provides a pre-search period again to detect an optimum oscillation frequency and carry out the main heating with that oscillation frequency.

This makes it possible to carry out efficient heating to the heating-target object and to also prevent the semiconductor elements contained in the power unit from being adversely affected by the reflected waves.

### CITATION LIST

### Patent Literature

PTL 1: Japanese Patent No. 5467341

### SUMMARY

When the reflected waves are large in the microwave processing apparatus disclosed in PTL 1, the electric power of the traveling waves is reduced to such a level that the reflected waves do not adversely affect the semiconductor elements of the power unit. When the reflected waves are small, the electric power of the traveling waves is increased so that the reflected waves become such as not to adversely affect the semiconductor elements of the power unit.

In the case where the apparatus is provided with a plurality of power units, when such an adjustment of electric power is performed for each of the power units, changes in power consumption distribution may be caused in the heating chamber (particularly in the heating-target object). Such changes in power consumption distribution may cause adverse effects on the processing of the heating-target object (i.e., irradiation target). If the power consumption distribution may change greatly or frequently, there is a possibility that the processing of the heating-target object (i.e., irradiation target) may become unstable and good results may not be obtained.

It is an object of the present disclosure to provide a radio wave emitting device that is able to improve stability of the processing of the irradiation target while protecting signal amplifiers.

According to an embodiment of the present disclosure, a radio wave emitting device includes a cavity, one or more signal generators, a plurality of signal amplifiers, a plurality of radio wave emitters, a plurality of measurers, and a controller.

The one or more signal generators generate one or more high frequency signals.

The plurality of signal amplifiers amplify the one or more high frequency signals to output a plurality of amplified high frequency signals. The plurality of radio wave emitters emit a plurality of radio waves into the cavity based on the plurality of amplified high frequency signals.

The plurality of measurers output one or both of temperature measurement values and reflected-wave electric power measurement values. Each of the temperature measurement values indicates a temperature of a corresponding one of the plurality of signal amplifiers. Each of the reflected-wave electric power measurement values indicates an electric power of a reflected wave flowing back through a corresponding one of the plurality of radio wave emitters. The controller controls the one or more signal generators and the plurality of signal amplifiers.

The controller switches an operation of the radio wave emitting device from a normal operation to a protection operation when it determines, during execution of the normal operation, that protection is necessary for at least one of the plurality of signal amplifiers based on one or both of the temperature measurement values and the reflected-wave power measurement values.

The normal operation includes setting electric power target values for the plurality of radio waves to respective normal target values for the plurality of radio wave emitters. The protection operation includes setting electric power target values for the plurality of radio waves to respective protection target values for the plurality of radio wave emitters.

For one or both of a protection target radio wave emitter corresponding to a signal amplifier for which protection is necessary and a radio wave emitter of the plurality of radio wave emitters other than the protection target radio wave emitter, the protection target value is lower than the normal target value.

The protection target values for the plurality of radio wave emitters are set in such a manner that a power consumption distribution in the cavity when executing the protection operation is closer to a power consumption distribution when executing the normal operation than a power consumption distribution when only the electric power target value of the protection target radio wave emitter is set to the protection target value.

In another embodiment of the present disclosure, a radio wave emitting device includes a cavity, one or more signal generators, a plurality of signal amplifiers, a plurality of radio wave emitters, a plurality of measurers, and a controller.

The one or more signal generators generate one or more high frequency signals.

The plurality of signal amplifiers amplify the one or more high frequency signals to output a plurality of amplified high frequency signals. The plurality of radio wave emitters emit a plurality of radio waves into the cavity based on the plurality of amplified high frequency signals.

The plurality of measurers output one or both of temperature measurement values and reflected-wave electric power measurement values. Each of the temperature measurement values indicates a temperature of a corresponding one of the plurality of signal amplifiers. Each of the reflected-wave electric power measurement values indicates an electric power of a reflected wave flowing back through a corresponding one of the plurality of radio wave emitters. The controller controls the one or more signal generators and the plurality of signal amplifiers.

The controller switches an operation of the radio wave emitting device from a normal operation to a protection operation when it determines, during execution of the normal operation, that protection is necessary for at least one of the plurality of signal amplifiers based on one or both of the temperature measurement values and the reflected-wave power measurement values.

The normal operation includes setting electric power target values for the plurality of radio waves to respective normal target values for the plurality of radio wave emitters. The protection operation includes setting electric power target values for the plurality of radio waves to respective protection target values for the plurality of radio wave emitters.

For the plurality of radio wave emitters, the protection target value is lower than the normal target value. A ratio of the protection target values for the plurality of radio wave emitters is equal to a ratio of the normal target values for the plurality of radio wave emitters.

The foregoing embodiments are able to improve stability of the processing of the irradiation target while protecting the signal amplifiers.

### BRIEF DESCRIPTION OF THE DRAWINGS

FIG. 1 is a schematic view illustrating a radio wave emitting device according to a first exemplary embodiment of the present disclosure.

FIG. 2 is a perspective view illustrating the external appearance of the radio wave emitting device according to the first exemplary embodiment.

FIG. 3 is a perspective view of the radio wave emitting device according to the first exemplary embodiment, illustrating the state in which the door is open.

FIG. 4 is a plan view of the radio wave emitting device according to the first exemplary embodiment, schematically illustrating the internal structure of the housing.

FIG. 5 is a front view of the radio wave emitting device according to the first exemplary embodiment, schematically illustrating the internal structure of the housing.

FIG. 6 is a cross-sectional view taken along line A-A in FIG. 4.

FIG. 7 is a cross-sectional view taken along line B-B in FIG. 5.

FIG. 8 is a perspective view illustrating the radio wave emitting device according to the first exemplary embodiment, a portion of which is omitted.

FIG. 9 is a flowchart illustrating an example of protection operation in radio wave emitting devices according to first to third exemplary embodiments.

FIG. 10 is a flowchart illustrating an example of protection operation of the radio wave emitting devices according to the first to third exemplary embodiments.

FIG. 11 is a waveform chart illustrating an example of the protection operation in the radio wave emitting device according to the first exemplary embodiment.

FIG. 12 is a view illustrating changes of the power consumption distribution inside an irradiation target disposed in the cavity of the radio wave emitting device according to the first exemplary embodiment.

FIG. 13 is a flowchart illustrating another example of protection operation in the radio wave emitting devices according to the first to third exemplary embodiments.

FIG. 14 is a flowchart illustrating another example of protection operation in the radio wave emitting devices according to the first to third exemplary embodiments.

FIG. 15 is a waveform chart illustrating another example of the protection operation in the radio wave emitting device according to the first exemplary embodiment.

FIG. 16 is a schematic view illustrating a radio wave emitting device according to a second exemplary embodiment of the present disclosure.

FIG. 17 is a plan view of the radio wave emitting device according to the second exemplary embodiment, schematically illustrating the internal structure of the housing.

FIG. 18 is a front view of the radio wave emitting device according to the second exemplary embodiment, schematically illustrating the internal structure of the housing.

FIG. 19 is a cross-sectional view taken along line C-C in FIG. 17.

FIG. 20 is a cross-sectional view taken along line D-D in FIG. 18.

FIG. 21 is a perspective view illustrating the radio wave emitting device according to the second exemplary embodiment, a portion of which is omitted.

FIG. 22 is a schematic view illustrating a radio wave emitting device according to a third exemplary embodiment of the present disclosure.

FIG. 23 is a plan view of the radio wave emitting device according to the third exemplary embodiment, schematically illustrating the internal structure of the housing.

FIG. 24 is a front view of the radio wave emitting device according to the third exemplary embodiment, schematically illustrating the internal structure of the housing.

FIG. 25 is a cross-sectional view taken along line E-E in FIG. 22.

FIG. 26 is a cross-sectional view taken along line F-F in FIG. 22.

FIG. 27 is a perspective view illustrating the radio wave emitting device according to the third exemplary embodiment, a portion of which is omitted.

### DESCRIPTION OF EMBODIMENTS

Hereafter, exemplary embodiments of the present disclosure will be described in detail with reference to the drawings. However, detailed description may not be provided for well-known matters and repetitive description of the same structures or substantially the same structures may be omitted.

### 1. Exemplary Embodiments

### 1.1 First Exemplary Embodiment

### [1.1.1 Configuration]

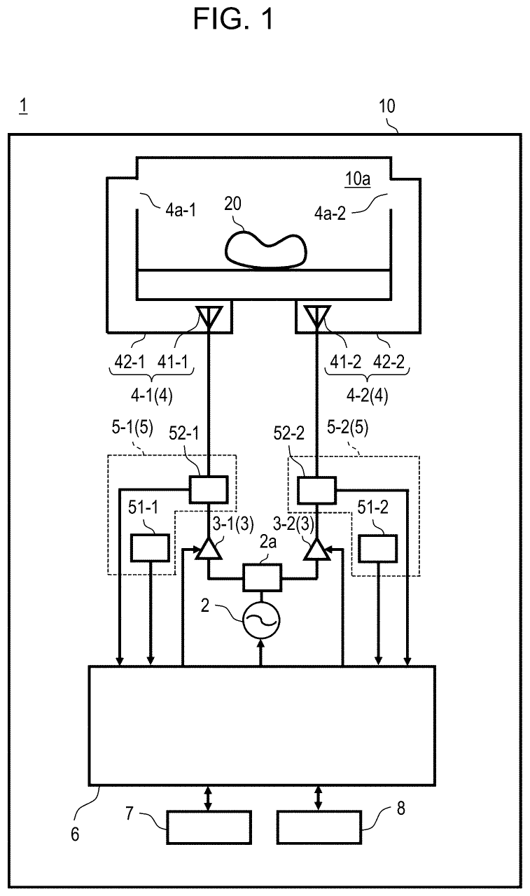

FIG. 1 is a schematic view illustrating radio wave emitting device 1 according to a first exemplary embodiment of the present disclosure. As illustrated in FIG. 1, radio wave emitting device 1 includes signal generator 2, electric power distributor 2a, signal amplifiers 3-1 and 3-2, radio wave emitters 4-1 and 4-2, measurers 5-1 and 5-2, controller 6, memory storage 7, input/output unit 8, and housing 10.

Signal amplifiers 3-1 and 3-2 mean the first one of signal amplifiers 3 and the second one of signal amplifiers 3, respectively. This also applies to radio wave emitters 4-1 and 4-2 as well as measurers 5-1 and 5-2. Hereinafter, signal amplifiers 3-1 and 3-2 are collectively referred to as a plurality of signal amplifiers 3. Radio wave emitters 4-1 and 4-2 are collectively referred to as a plurality of radio wave emitters 4. Measurers 5-1 and 5-2 are collectively referred to as a plurality of measurers 5.

On the other hand, when simply signal amplifier 3 is referred to, it means one of signal amplifiers 3-1 and 3-2. When simply radio wave emitter 4 is referred to, it means either of radio wave emitters 4-1 and 4-2. When simply measurer 5 is referred to, it means one of measurers 5-1 and 5-2.

Housing 10 accommodates signal generator 2, electric power distributor 2a, signal amplifiers 3-1 and 3-2, radio wave emitters 4-1 and 4-2, measurers 5-1 and 5-2, controller 6, memory storage 7, and input/output unit 8. Housing 10 includes cavity 10a that is able to accommodate irradiation target 20.

Irradiation target 20 is an object that is irradiated with the radio waves generated by radio wave emitting device 1. In the present exemplary embodiment, radio wave emitting device 1 emits radio waves to irradiation target 20 to dielectrically heat irradiation target 20. Thus, in the present exemplary embodiment, cavity 10a is a heating chamber and irradiation target 20 is a heating-target object.

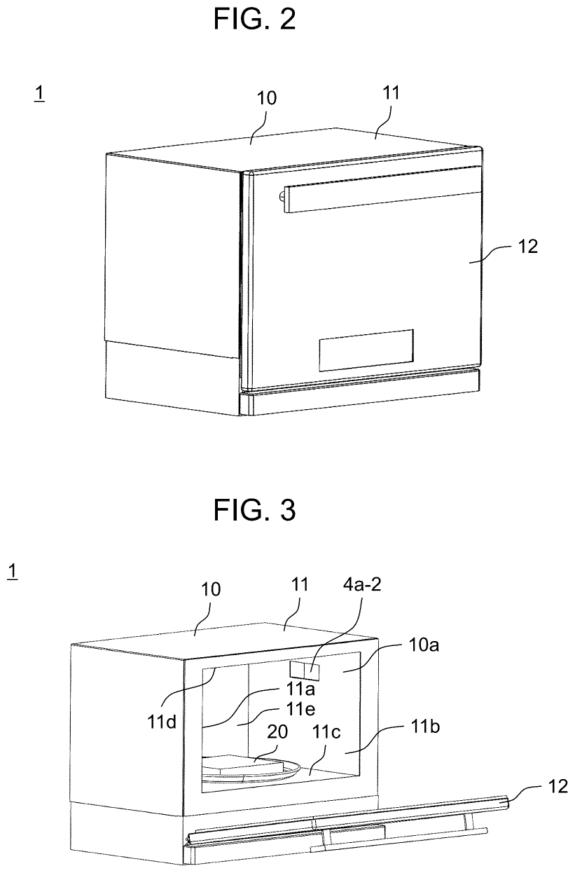

FIG. 2 is a perspective view illustrating the external appearance of radio wave emitting device 1. FIG. 3 is a perspective view of radio wave emitting device 1 illustrating the state in which door 12 is open. As illustrated in FIGS. 2 and 3, housing 10 of radio wave emitting device 1 includes main body 11 and door 12. Main body 11 has a rectangular parallelepiped shape. Main body 11 includes cavity 10a inside.

Cavity 10a is formed of a plurality of wall surfaces (left wall surface 11a, right wall surface 11b, bottom wall surface 11c, top wall surface 11d, and back wall surface 11e) that are composed of a material that shields radio waves. Door 12 is fitted to a front surface of main body 11 to cover the front opening of main body 11. Door 12 is also composed of a material that shields radio waves. This allows cavity 10a to confine the radio waves (microwaves) supplied from the plurality of radio wave emitters 4 to its inside.

In the present disclosure, the term “shielding” means reducing the energy of radio wave energy by absorption or the like, and confining radio waves within cavity 10 by reflection, multiple reflection, or the like. Therefore, the material that shields radio waves should be any material that can obtain the effect of such “shielding”. Examples of the material that shields radio waves include materials that reflect radio waves, such as metallic materials, and materials that absorb radio waves, such as ferrite rubber.

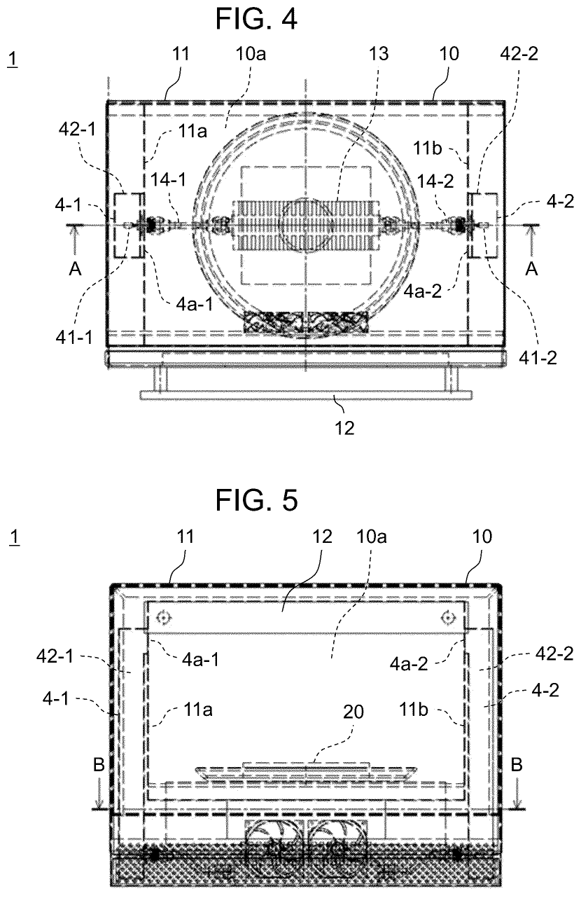

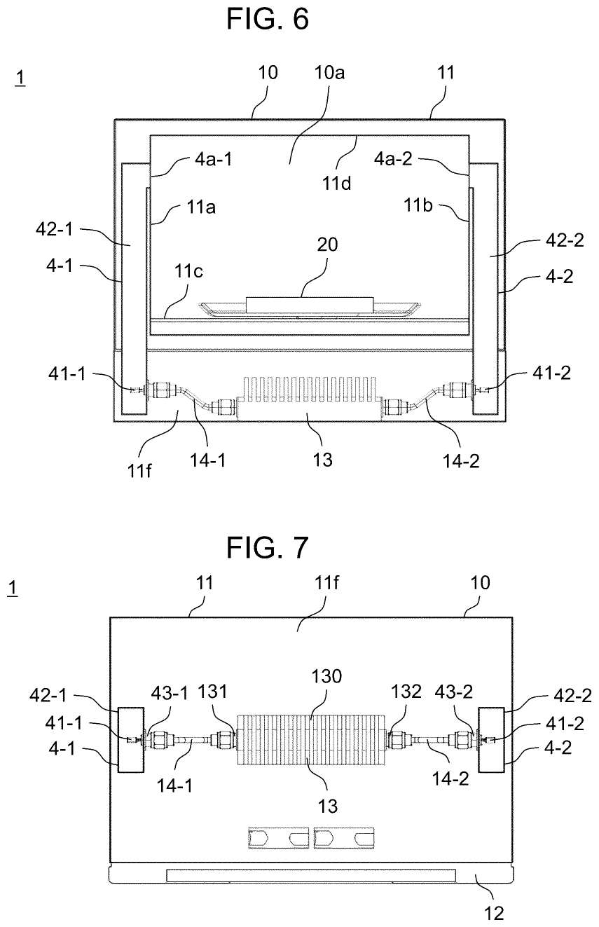

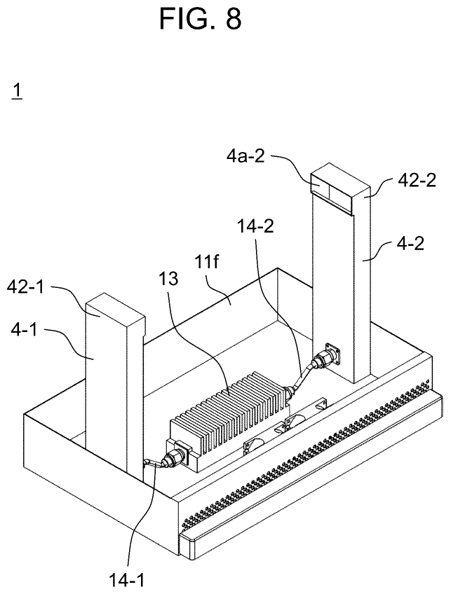

FIG. 4 is a plan view of radio wave emitting device 1, schematically illustrating the internal structure of housing 10. FIG. 5 is a front view of radio wave emitting device 1, schematically illustrating the internal structure of housing 10. FIG. 6 is a cross-sectional view taken along line A-A in FIG. 4. FIG. 7 is a cross-sectional view taken along line B-B in FIG. 5. FIG. 8 is a perspective view illustrating radio wave emitting device 1, a portion of which is omitted.

As illustrated in FIGS. 6, 7, and 8, main body 11 includes housing space 11f below cavity 10a. Housing space 11f accommodates high frequency signal generating unit 13. High frequency signal generating unit 13 includes housing 130 in a substantially rectangular parallelepiped shape. Housing 130 accommodates signal generator 2, electric power distributor 2a, the plurality of signal amplifiers 3, the plurality of measurers 5, controller 6, and memory storage 7.

High frequency signal generating unit 13 includes first port 131 and second port 132. First port 131 and second port 132 output amplified high frequency signals sent from signal amplifiers 3-1 and 3-2, respectively. First port 131 and second port 132 are, for example, coaxial connectors to which coaxial cables can be connected.

In FIG. 1, signal generator 2 generates a high frequency signal having any frequency within a band of, for example, 300 MHz to 10 GHz.

Signal generator 2 is composed of a voltage-controlled resonant circuit. In order to generate a plurality of high frequency signals in a wider frequency band, signal generator 2 may include a PLL (Phase-Locked Loop) frequency synthesizer.

Electric power distributor 2a is connected between signal generator 2 and each of signal amplifiers 3-1 and 3-2. Electric power distributor 2a supplies high frequency signals sent from signal generator 2 to signal amplifiers 3-1 and 3-2.

Signal amplifier 3 amplifies the high frequency signals sent from signal generator 2. Each of signal amplifiers 3-1 and 3-2 amplifies the supplied high frequency signals and outputs amplified high frequency signals.

When an amplified high frequency signal having a frequency contained in the foregoing frequency band is emitted to irradiation target 20, which is a dielectric material, heat is generated inside irradiation target 20. By this heat, irradiation target 20 can be heated.

Signal amplifiers 3-1 and 3-2 are connected to first port 131 and second port 132 (for both, see FIG. 7), respectively. Thus, first port 131 outputs the amplified high frequency signal from signal amplifier 3-1. Second port 132 outputs the amplified high frequency signal from signal amplifier 3-2.

The plurality of radio wave emitters 4 emit a plurality of radio waves into cavity 10a based on the amplified high frequency signals from the plurality of signal amplifiers 3. Specifically, radio wave emitter 4-1 emits a radio wave into cavity 10a based on the amplified high frequency signal from signal amplifier 3-1. Radio wave emitter 4-2 emits a radio wave into cavity 10a based on the amplified high frequency signal from signal amplifier 3-2.

Radio wave emitter 4-1 includes antenna 41-1 and waveguide 42-1. Radio wave emitter 4-2 includes antenna 41-2 and waveguide 42-2.

As illustrated in FIG. 7, radio wave emitter 4-1 includes connector 43-1 connected to antenna 41-1. Radio wave emitter 4-2 includes connector 43-2 connected to antenna 41-2. Connector 43-1 is connected to first port 131 via connecting cable 14-1. Connector 43-2 is connected to second port 132 via connecting cable 14-2.

In this way, antennas 41-1 and 41-2 are connected to signal amplifiers 3-1 and 3-2, respectively. Antennas 41-1 and 41-2 emit radio waves based on amplified high frequency signals from signal amplifiers 3-1 and 3-2, respectively. Connectors 43-1 and 43-2 are, for example, coaxial connectors to which coaxial cables can be connected, and connecting cables 14-1 and 14-2 are coaxial cables.

As illustrated in FIG. 1, waveguides 42-1 and 42-2 guide the radio waves emitted from antennas 41-1 and 41-2, respectively, into cavity 10a. As illustrated in FIGS. 5, 6, and 8, waveguides 42-1 and 42-2 each have a rectangular parallelepiped shape extending in a vertical direction.

As illustrated in FIG. 6, first ends (specifically, lower ends) of waveguides 42-1 and 42-2 are disposed inside housing space 11f. As illustrated in FIG. 7, antennas 41-1 and 41-2 are disposed inside waveguides 42-1 and 42-2 near the first ends, respectively. Connectors 43-1 and 43-2 are disposed outside waveguides 42-1 and 42-2 near the first ends, respectively.

Antennas 41-1 and 41-2 are connected to connectors 43-1 and 43-2, respectively. Openings 4a-1 and 4a-2 are formed in the side surfaces of second ends (specifically, upper ends) of waveguides 42-1 and 42-2, respectively. Opening 4a-1 is disposed in left wall surface 11a of main body 11 to communicate cavity 10a and waveguide 42-1 with each other. This allows the radio wave emitted from antenna 41-1 to be emitted through waveguide 42-1 and opening 4a-1 into cavity 10a.

Opening 4a-2 is disposed in right wall surface 11b of main body 11 to communicate cavity 10a and waveguide 42-2 with each other. This allows the radio wave emitted from antenna 41-2 to be emitted through waveguide 42-2 and opening 4a-2 into cavity 10a.

As illustrated in FIG. 1, the plurality of measurers 5 output temperature measurement values, which indicate the temperatures of the plurality of signal amplifiers 3, and a plurality of reflected-wave electric power measurement values. Specifically, measurer 5-1 outputs a temperature measurement value, which indicates the temperature of signal amplifier 3-1, and a reflected-wave electric power measurement value, which indicates the electric power of the reflected wave that flows back through radio wave emitter 4-1. Measurer 5-2 outputs a temperature measurement value, which indicates the temperature of signal amplifier 3-2, and a reflected-wave electric power measurement value, which indicates the electric power of the reflected wave that flows back through radio wave emitter 4-2.

Measurer 5-1 includes temperature measurer 51-1 and electric power measurer 52-1. Measurer 5-2 includes temperature measurer 51-2 and electric power measurer 52-2.

Temperature measurers 51-1 and 51-2 include temperature sensors disposed near signal amplifiers 3-1 and 3-2, respectively. This allows temperature measurers 51-1 and 51-2 to measure the temperatures of signal amplifiers 3-1 and 3-2, respectively. Temperature measurers 51-1 and 51-2 output temperature measurement values that indicate the temperatures of signal amplifiers 3-1 and 3-2, respectively, to controller 6.

The temperature of signal amplifier 3 may not necessarily be the temperature of signal amplifier 3 in a strict sense, but may be a temperature that can be considered as the temperature of signal amplifier 3. Temperature measurers 51-1 and 51-2 each may be composed of a known temperature sensor.

Electric power measurer 52-1 is connected between signal amplifier 3-1 and radio wave emitter 4-1. Electric power measurer 52-2 is connected between signal amplifier 3-2 and radio wave emitter 4-2.

Electric power measurer 52-1 measures the electric power of the amplified high frequency signal that is supplied from signal amplifier 3-1 to radio wave emitter 4-1 for the purpose of emitting radio waves into cavity 10a. Electric power measurer 52-2 measures the electric power of the amplified high frequency signal that is supplied from signal amplifier 3-2 to radio wave emitter 4-2 for the purpose of emitting radio waves into cavity 10a.

The amplified high frequency signals emitted from radio wave emitters 4-1 and 4-2 as radio waves are called traveling waves. Electric power measurers 52-1 and 52-2 output the traveling-wave electric power measurement values, which indicate the measured electric power of the traveling waves, to controller 6.

In addition, electric power measurer 52-1 measures the electric power of a reflected wave that flows back toward signal amplifier 3-1 through radio wave emitter 4-1. Electric power measurer 52-2 measures the electric power of a reflected wave that flows back toward signal amplifier 3-2 through radio wave emitter 4-2.

The reflected waves include radio waves that are not emitted from radio wave emitter 4 into cavity 10a due to impedance mismatch, and radio waves emitted by radio wave emitter 4 that are reflected inside cavity 10a without being absorbed by irradiation target 20 and returned to radio wave emitter 4. Electric power measurers 52-1 and 52-2 output the reflected-wave electric power measurement values, which indicate the measured electric power of the reflected waves, to controller 6.

Thus, electric power measurers 52-1 and 52-2 measure traveling-wave electric power and reflected-wave electric power. Electric power measurers 52-1 and 52-2 are composed of, for example, a directional coupler, a detector circuit, and the like.

Memory storage 7 is a memory storage device for storing information that is utilized by controller 6 and information that is generated by controller 6. Memory storage 7 includes one or more non-transitory memory storage media. The memory storage media may be semiconductor memories, including RAM (Random Access Memory) and ROM (Read Only Memory).

In the present exemplary embodiment, the memory storage medium is a flash memory. The memory storage medium is not limited to a semiconductor memory but may be any type of memory storage medium such as HDD (Hard Disc Drive), optical drive, SSD (Solid State Drive), internal type, external type, and NAS (Network-Attached Storage) type.

Input/output unit 8 functions as an input device for inputting information from the user and as an output device for outputting information to the user. Input/output unit 8 includes one or more human-machine interfaces. Specifically, the human-machine interfaces may include: an input device such as a mechanical switch, a touchpad, and a microphone; an output device such as a display and a speaker; and an input/output device such as a touchscreen panel.

Input/output unit 8 includes a communication interface. The communication interface communicates with an external central device or terminal device by a predetermined communication mode. This allows the communication interface to perform information inputting to radio wave emitting device 1 and information outputting from radio wave emitting device 1.

The external central device may be an industrial FA (Factory Automation) computer or the like that functions as the master of the communication network. The terminal device may be a personal computer, a smartphone, a tablet computer, a wearable terminal, and the like that are owned by the user.

Controller 6 controls signal generator 2 and the plurality of signal amplifiers 3. This allows radio wave emitting device 1 to emit a plurality of radio waves from the plurality of radio wave emitters 4 into cavity 10a, to heat irradiation target 20.

Controller 6 is composed of, for example, a microcontroller including one or more processors and memories. Controller 6 may be composed of, for example, a FPGA (Field-Programmable Gate Array), an ASIC (Application Specific Integrated Circuit), or the like.

Controller 6 controls the frequency and electric power of traveling waves. For that purpose, controller 6 causes signal generator 2 to change the frequency of high frequency signal and signal amplifier 3 to change the amplification factor.

Controller 6 may also control the electric power of traveling waves by means of, for example, changing the voltage of the internal power supply connected to signal amplifier 3. Controller 6 may also change the amplification factor of signal amplifier 3 by a variable attenuator.

Controller 6 selectively executes a normal operation and a protection operation. The normal operation is an operation that is aimed at emitting radio waves to irradiation target 20. The protection operation is an operation that is aimed at protecting signal amplifier 3 while emitting radio waves to irradiation target 20. Controller 6 switches the operation of radio wave emitting device 1 from the normal operation to the protection operation when it is necessary to protect signal amplifier 3 while the normal operation is being executed.

In the present exemplary embodiment, controller 6 switches the operation of radio wave emitting device 1 from the normal operation to the protection operation when it judges, during execution of the normal operation, that protection is necessary for at least one of signal amplifiers 3-1 and 3-2 based on at least one of the temperature measurement value and the reflected-wave electric power measurement value.

In the present exemplary embodiment, the protection operation is executed when it is determined necessary based on temperature and when it is determined necessary based on reflected electric power. The former is referred to as a temperature-based protection operation and the latter is referred to as an electric power-based protection operation.

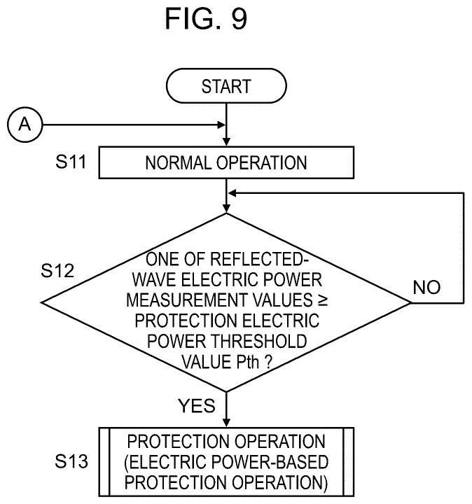

Hereinafter, an example of the normal operation and the protection operation of controller 6 will be described with reference to FIGS. 9 to 11.

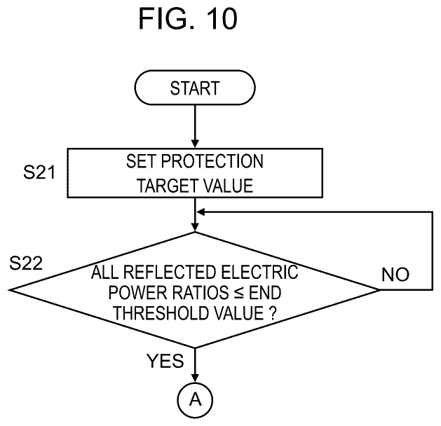

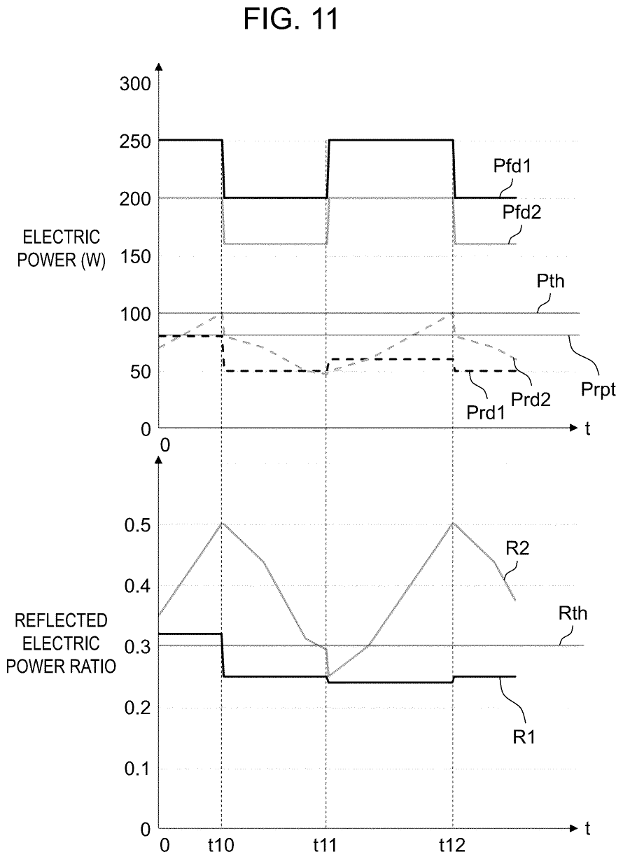

FIG. 9 is a flowchart illustrating an example of the protection operation in radio wave emitting device 1. In the present exemplary embodiment, an example of the protection operation of radio wave emitting device 1 is the electric power-based protection operation. FIG. 10 is a flowchart illustrating the electric power-based protection operation. FIG. 11 is a waveform chart illustrating the electric power-based protection operation.

In FIG. 11, Pfd1 represents the traveling-wave electric power measurement value of radio wave emitter 4-1, and Pfd2 represents the traveling-wave electric power measurement value of radio wave emitter 4-2. Prd1 represents the reflected-wave electric power measurement value of radio wave emitter 4-1, and Prd2 represents the reflected-wave electric power measurement value of radio wave emitter 4-2. R1 represents the reflected electric power ratio of radio wave emitter 4-1, and R2 represents the reflected electric power ratio of radio wave emitter 4-2. Note that the reflected electric power ratio is obtained by dividing the reflected-wave electric power measurement value by the traveling-wave electric power measurement value.

As illustrated in FIG. 9, controller 6 first executes the normal operation (step S11). The normal operation includes setting electric power target values for the plurality of radio waves emitted from the plurality of radio wave emitters 4 to respective normal target values for the plurality of radio wave emitters 4. For an example, the normal target value for radio wave emitter 4-1 is 250 W and the normal target value for radio wave emitter 4-2 is 200 W.

Controller 6 determines whether or not protection is necessary for at least one of signal amplifiers 3-1 and 3-2 based on the reflected-wave electric power measurement value. In the present exemplary embodiment, controller 6 determines whether or not at least one of reflected-wave electric power measurement values Prd1 and Prd2 is higher than or equal to protection electric power threshold value Pth (see FIG. 11).

This allows controller 6 to determine whether or not protection is necessary for at least one of signal amplifiers 3-1 and 3-2 (step S12). In other words, controller 6 determines that protection is necessary for signal amplifier 3 that corresponds to a reflected-wave electric power measurement value that is higher than or equal to the protection electric power threshold value Pth.

If the determination result at step S12 is YES, controller 6 switches the operation of radio wave emitting device 1 from the normal operation to the protection operation (the reflected-wave electric power-based protection operation in this case) (step S13). Protection electric power threshold value Pth is set in advance so that signal amplifier 3 can be protected from the reflected waves. For example, protection electric power threshold value Pth may be 100 W.

As illustrated in FIG. 11, at time t10, controller 6 determines, during execution of the normal operation, that the reflected-wave electric power measurement value Prd2 is higher than or equal to protection electric power threshold value Pth, and switches the operation of radio wave emitting device 1 from the normal operation to the protection operation.

As illustrated in FIG. 10, the protection operation includes setting electric power target values for the plurality of radio waves emitted from the plurality of radio wave emitters 4 to respective protection target values for the plurality of radio wave emitters 4 (step S21). For one or both of protection target radio wave emitter 4, which corresponds to signal amplifier 3 for which protection is necessary, and radio wave emitter 4 of the plurality of radio wave emitters 4 other than protection target radio wave emitter 4, the protection target value is lower than the normal target value.

In the present exemplary embodiment, the protection target value is lower than the normal target value for all radio wave emitters 4, irrespective of whether radio wave emitter 4 is the protection target.

The protection target value for the plurality of radio wave emitters 4 is set so that the power consumption distribution in cavity 10a when executing the protection operation is closer to that when executing the normal operation than that when only the electric power target value of protection target radio wave emitter 4 is set to the protection target value.

Essentially, when considering only the protection for signal amplifier 3, only the electric power target value of protection target radio wave emitter 4 should be set to a protection target value that is smaller than the normal target value. However, in the present exemplary embodiment, for radio wave emitter 4 other than protection target radio wave emitter 4 as well, the electric power target value is set to be a protection target value that is smaller than the normal target value, in order to prevent the power consumption distribution from varying greatly between the normal operation and the protection operation.

The case where “the power consumption distribution in cavity 10a when executing the protection operation is closer to that when executing the normal operation than that when only the electric power target value of protection target radio wave emitter 4 is set to the protection target value” is, for example, the following case.

An example is the case in which, concerning the power consumption distribution in cavity 10a, the degree of match between when executing the protection operation and when executing the normal operation is higher than the degree of match between when only the electric power target value of protection target radio wave emitter 4 is set to the protection target value and when executing the normal operation. The degree of match refers to, for example, the degree of match between a pattern obtained by normalizing the power consumption distribution in the normal operation and that in the protection operation.

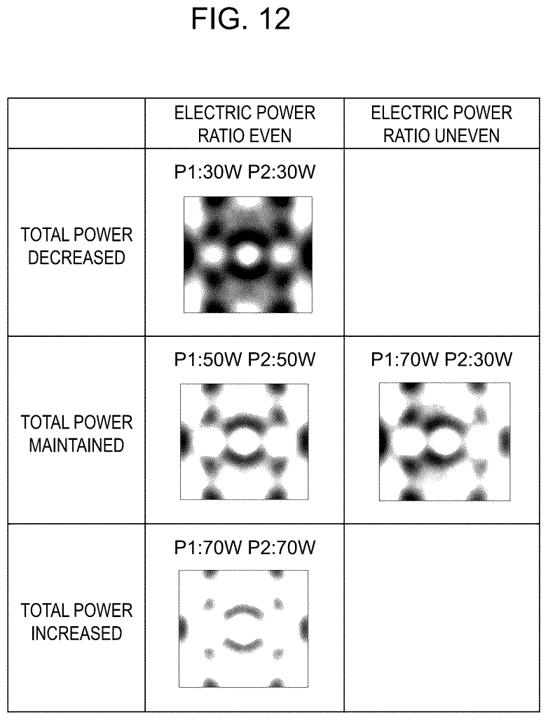

FIG. 12 is a view illustrating changes of the power consumption distribution within irradiation target 20 disposed in cavity 10a. More specifically, FIG. 12 illustrates changes of the power consumption distribution when the electric power target values for radio wave emitters 4-1 and 4-2 are changed.

In FIGS. 12, P1 and P2 respectively represent the electric power target values for radio wave emitters 4-1 and 4-2. The column denoted as “electric power ratio even” shows the cases where the ratio of P1 and P2 is 1:1. The column denoted as “electric power ratio uneven” shows the cases where the ratio of P1 and P2 is 7:3.

The row denoted as “total power maintained” shows the cases where the total of P1 and P2 is 100 W. The row denoted as “total power decreased” shows the cases where the total of P1 and P2 is 60 W, which is lower than the total of P1 and P2 in the row denoted as “total power maintained” (100 W). The row denoted as “total power increased” shows the cases where the total of P1 and P2 is 140 W, which is higher than the total of P1 and P2 in the row denoted as “total power maintained” (100 W).

As shown in the column denoted as “electric power ratio even” in FIG. 12, when the ratio of electric power target values P1 and P2 is constant, the power consumption distribution within cavity 10a is not changed. As shown in the column denoted as “total power maintained”, when the ratio of electric power target values P1 and P2 is different, the power consumption distribution within cavity 10a tends to change.

According to this finding, the ratio of the protection target values for radio wave emitters 4-1 and 4-2 is equal to the ratio of the normal target values for radio wave emitters 4-1 and 4-2 in the present exemplary embodiment. This enables the power consumption distribution in cavity 10a when executing the protection operation to be closer to that when executing the normal operation than that when only the electric power target value of protection target radio wave emitter 4 is set to the protection target value.

Note that the term “equal” in the above description is meant to include not just strictly equal but also substantially equal.

The ratio of the protection target values for radio wave emitters 4-1 and 4-2 means the ratio of the protection target value for radio wave emitter 4-1 and the protection target value for radio wave emitter 4-2. Hereinafter, this is referred to as the ratio of protection target values for the plurality of radio wave emitters 4. Specifically, the ratio of protection target values for the plurality of radio wave emitters 4 means the ratio of a plurality of protection target values each corresponding to one of the plurality of radio wave emitters 4. The same also applies to the ratio of normal target values for the plurality of radio wave emitters 4.

Setting of protection target values will be described in further detail. In the present exemplary embodiment, the protection operation (electric power-based protection operation) includes determining the protection target values for radio wave emitters 4-1 and 4-2 so that all the reflected-wave electric power measurement values fall below the protection electric power threshold value Pth.

More specifically, the electric power-based protection operation determines a protection target value for radio wave emitter 4 corresponding to the maximum reflected-wave electric power measurement value among the plurality of radio wave emitters 4 (that is, protection target radio wave emitter 4), based on the reflected-wave electric power measurement value of radio wave emitter 4 that has the maximum reflected-wave electric power measurement value among the plurality of radio wave emitters 4.

More specifically, the protection operation (electric power-based protection operation) determines the protection target value for radio wave emitter 4 other than protection target radio wave emitter 4 of the plurality of radio wave emitters 4, from the ratio of the normal target value for radio wave emitter 4-1 and the normal target value for radio wave emitter 4-2, and the protection target value for radio wave emitter 4 among the plurality of radio wave emitters 4 that corresponds to the maximum reflected-wave electric power measurement value. As described previously, in the present exemplary embodiment, the ratio of the protection target values for the plurality of radio wave emitters 4 is equal to the ratio of the normal target values for the plurality of radio wave emitters 4.

As an example, the protection target value is determined according to the following Eq. (1).

$$\text{?} \qquad Eq . ( 1 )$$

$$\text{?} \text{indicates text missing or illegible when filed}$$

In Eq. (1), the variable x represents the ordinal number of arbitrary radio wave emitter 4. The variable y represents the ordinal number of radio wave emitter 4 that corresponds to the maximum reflected-wave electric power measurement value, among the plurality of radio wave emitters 4. The variables x and y are integers greater than or equal to 1 (x and y are 2 in the present exemplary embodiment). That is, Pfnx represents the protection target value for the x-th one of radio wave emitters 4. Prpt represents the target value of the electric power for the reflected waves during the protection operation.

The target value Prpt is lower than protection electric power threshold value Pth. This makes it possible to set the protection target values for radio wave emitters 4-1 and 4-2 so that the reflected-wave electric power measurement value during execution of the protection operation will be lower than the protection electric power threshold value Pth.

Pfdy represents the traveling-wave electric power measurement value supplied to the y-th one of radio wave emitters 4. Prdmax represents the maximum reflected-wave electric power measurement value. Therefore, in Eq. (1), Pfdy/Prdmax represents the ratio of traveling-wave electric power measurement value and reflected-wave electric power measurement value in radio wave emitter 4 corresponding to the maximum reflected-wave electric power measurement value.

Pfx represents the normal target value for the x-th one of radio wave emitter 4. Pfy represents the normal target value for radio wave emitter 4 corresponding to the maximum reflected-wave electric power measurement value. Therefore, in Eq. (1), Pfx/Pfy represents the ratio of the normal target value for arbitrary radio wave emitter 4 to the normal target value for radio wave emitter 4 corresponding to the maximum reflected-wave electric power measurement value.

As illustrated in FIG. 11, at time t10, reflected-wave electric power measurement value Prd1 of radio wave emitter 4-1 is 80 W and reflected-wave electric power measurement value Prd2 of radio wave emitter 4-2 is 100 W. Therefore, of the plurality of radio wave emitters 4, radio wave emitter 4 corresponding to the maximum reflected-wave electric power measurement value is radio wave emitter 4-2.

In this example, radio wave emitter 4-2 is protection target radio wave emitter 4, and radio wave emitter 4-1 is radio wave emitter 4 of the plurality of radio wave emitters 4 other than protection target radio wave emitter 4. Accordingly, protection target value Pfn2 for radio wave emitter 4-2 is determined based on reflected-wave electric power measurement value Prd2 of radio wave emitter 4-2.

For example, it is assumed that target value Prpt is 80 W and traveling-wave electric power measurement value Pfd2 of radio wave emitter 4-2 is equal to normal target value Pf2. In this case, protection target value Pfn2 for radio wave emitter 4-2 is 160 (=80*(200/100)*(200/200)).

As described previously, normal target value Pf1 for radio wave emitter 4-1 is 250 W and normal target value Pf2 for radio wave emitter 4-2 is 200 W. Therefore, protection target value Pfn1 for radio wave emitter 4-1 is 200 (=80*(200/100)*(250/200)).

As described above, protection target value Pfn1 is 200 W, and protection target value Pfn2 is 160 W. The ratio of protection target values Pfn1 and Pfn2 (for example, 200:160=5:4) is equal to the ratio of normal target values Pf1 and Pf2 (for example, 250:200=5:4).

Protection target value Pfn1 for radio wave emitter 4-1 is set to 200 W and protection target value Pfn2 for radio wave emitter 4-2 is set to 160 W. As a result, before and after time t10, traveling-wave electric power measurement value Pfd1 of radio wave emitter 4-1 decreases from 250 W to 200 W, and traveling-wave electric power measurement value Pfd2 of radio wave emitter 4-2 decreases from 200 W to 160 W.

As illustrated in FIG. 10, controller 6 determines whether or not reflected electric power ratio R1 of radio wave emitter 4-1 and reflected electric power ratio R2 of radio wave emitter 4-2 fall below end threshold value Rth. If the determination result at step S22 is YES, controller 6 switches the operation of radio wave emitting device 1 from the protection operation to the normal operation.

End threshold value Rth defines the reflected electric power ratio when ending the protection operation. The reflected electric power ratio when the protection operation is ended is lower than the reflected electric power ratio when starting the protection operation. As an example, protection electric power threshold value Pth is 100 W.

Assuming that traveling-wave electric power measurement value Pfd1 is equal to normal target value Pf1 in radio wave emitter 4-1, reflected electric power ratio (Pth/Pfd1) when starting the protection operation is 0.4 (=100/250).

Assuming that traveling-wave electric power measurement value Pfd2 is equal to normal target value Pf2 in radio wave emitter 4-2, reflected electric power ratio (Pth/Pfd2) when starting the protection operation is 0.5 (=100/200). In the present exemplary embodiment, end threshold value Rth is set to 0.3. The reflected-wave electric power measurement value when the reflected electric power ratio becomes equal to end threshold value Rth is called a return electric power threshold value.

Assuming that traveling-wave electric power measurement value Pfd1 is equal to the protection target value, the return electric power threshold value (Rth×Pfd1) of radio wave emitter 4-1 is 60 (=0.3×200). Assuming that traveling-wave electric power measurement value Pfd2 is equal to the protection target value, the return electric power threshold value (Rth×Pfd2) of radio wave emitter 4-2 is 48 (=0.3×160).

In other words, at step S22, controller 6 switches the operation of radio wave emitting device 1 from the protection operation to the normal operation if controller 6 determines that all the reflected-wave electric power measurement values fall below the return electric power threshold value of radio wave emitter 4 during execution of the protection operation.

For each of the plurality of radio wave emitters, the return electric power threshold value is set so that the ratio of the return electric power threshold value to the traveling-wave electric power measurement value during execution of the protection operation is smaller than the ratio of protection electric power threshold value Pth to each of the traveling-wave electric power measurement values during execution of the normal operation.

As illustrated in FIG. 11, at time t10, both the reflected electric power ratios of radio wave emitters 4-1 and 4-2 fall below 0.3. Specifically, reflected-wave electric power measurement value Prd1 of radio wave emitter 4-1 falls below 60 W, which is the return electric power threshold value of radio wave emitter 4-1, and reflected-wave electric power measurement value Prd2 of radio wave emitter 4-2 falls below 48 W, which is the return electric power threshold value of radio wave emitter 4-2.

Therefore, controller 6 switches the operation of radio wave emitting device 1 from the protection operation to the normal operation. Accordingly, controller 6 sets the electric power target values for a plurality of radio waves emitted from the plurality of radio wave emitters 4 to the respective normal target values for the plurality of radio wave emitters 4 (see step S11 in FIG. 9). As a result, before and after time t11, traveling-wave electric power measurement value Pfd1 increases from 200 W to 250 W, and traveling-wave electric power measurement value Pfd2 increases from 160 W to 200 W.

At time t12, controller 6 determines that the reflected-wave electric power measurement value Prd2 is higher than or equal to protection electric power threshold value Pth during execution of the normal operation, and again switches the operation of radio wave emitting device 1 from the normal operation to the protection operation.

Thus, if controller 6 determines that at least one of reflected-wave electric power measurement values Prd1 and Prd2 is higher than or equal to protection electric power threshold value Pth during execution of the normal operation, controller 6 switches the operation of radio wave emitting device 1 from the normal operation to the protection operation. For one or both of protection target radio wave emitter 4, which corresponds to signal amplifier 3 for which protection is necessary, and radio wave emitter 4 of the plurality of radio wave emitters 4 other than protection target radio wave emitter 4, the protection target value is lower than the normal target value.

The protection target value for the plurality of radio wave emitters 4 is set so that the power consumption distribution in cavity 10a when executing the protection operation is closer to that when executing the normal operation than that when only the electric power target value of protection target radio wave emitter 4 is set to the protection target value. As a result, it becomes possible to improve stability of the processing of irradiation target 20 while protecting signal amplifier 3.

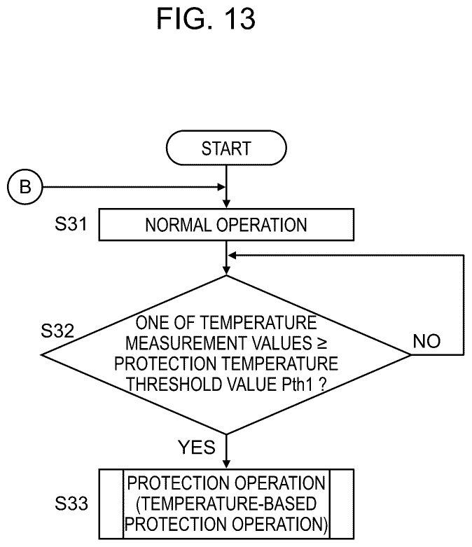

Hereinafter, another example of the normal operation and the protection operation of controller 6 will be described with reference to FIGS. 13 to 15.

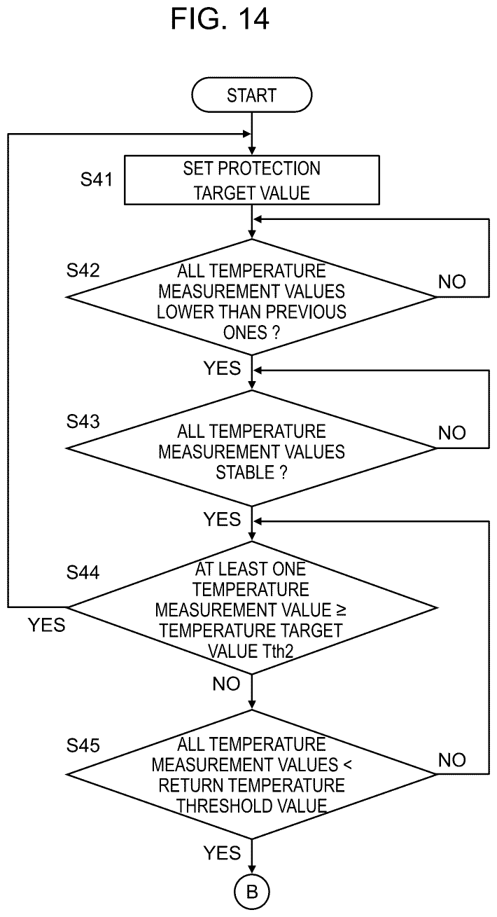

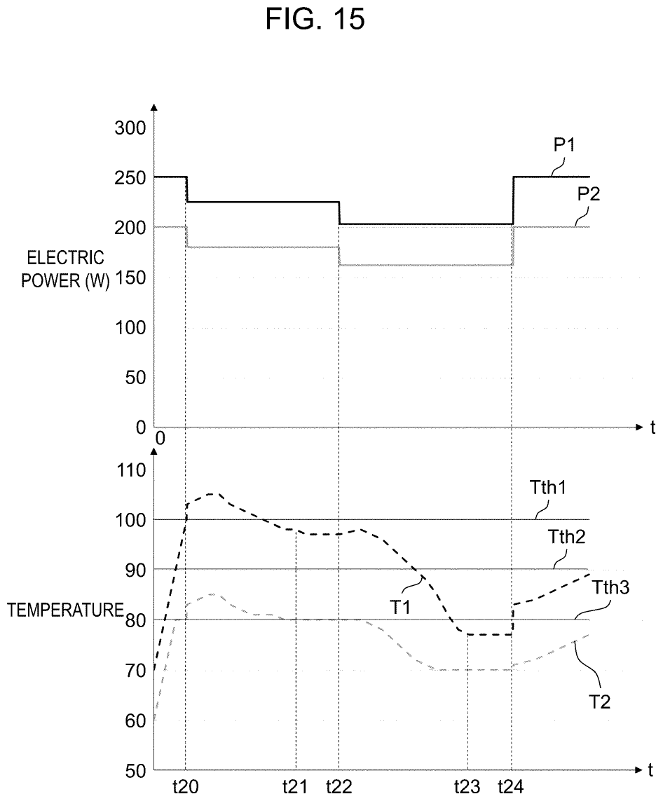

FIG. 13 is a flowchart illustrating another example of the protection operation in radio wave emitting device 1. In the present exemplary embodiment, another example of the protection operation of radio wave emitting device 1 is the temperature-based protection operation. FIG. 14 is a flowchart illustrating the temperature-based protection operation. FIG. 15 is a waveform chart illustrating the temperature-based protection operation.

In FIGS. 15, P1 and P2 respectively represent the electric power target values for radio wave emitters 4-1 and 4-2. T1 and T2 respectively represent temperature measurement values that indicate the temperatures of signal amplifiers 3-1 and 3-2.

As illustrated in FIG. 13, controller 6 first executes the normal operation (step S31). The normal operation includes setting electric power target values for the plurality of radio waves emitted from the plurality of radio wave emitters 4 to respective normal target values for the plurality of radio wave emitters 4. As an example, normal target value Pf1 for radio wave emitter 4-1 is 250 W and normal target value Pf1 for radio wave emitter 4-2 is 200 W.

Controller 6 determines, during execution of the normal operation, whether or not at least one of temperature measurement values T1 and T2 is higher than or equal to protection temperature threshold value Tth1 (see FIG. 15) (step S32). This allows controller 6 to determine whether or not protection is necessary for at least one of the plurality of signal amplifiers 3.

In other words, controller 6 determines that protection is necessary for signal amplifier 3 corresponding to a reflected-wave electric power measurement value that is higher than or equal to protection temperature threshold value Tth1. If the determination result at step S32 is NO, controller 6 repeats the process of step S32.

When the determination result at step S32 turns to YES, controller 6 switches the operation of radio wave emitting device 1 from the normal operation to the protection operation (the temperature-based protection operation in this case) (step S33). Protection temperature threshold value Tth1 is determined in advance so that the temperature of signal amplifier 3 falls within a temperature range in which signal amplifier 3 is able to operate stably. Protection temperature threshold value Tth1 may be, for example, 100 degrees.

It is possible that the temperature of signal amplifier 3 may increase due to an increase of the reflected-wave electric power inside cavity 10a, in addition to the heat generated by signal amplifier 3 itself.

As illustrated in FIG. 15, at time t20, controller 6 determines, during execution of the normal operation, that temperature measurement value T1 is higher than or equal to protection temperature threshold value Tth1, and switches the operation of radio wave emitting device 1 from the normal operation to the protection operation.

As illustrated in FIG. 14, the temperature-based protection operation includes setting electric power target values for the plurality of radio waves emitted from the plurality of radio wave emitters 4 to respective protection target values for the plurality of radio wave emitters 4 (step S41). For at least one of the plurality of radio wave emitters 4, the protection target value is smaller than the normal target value. In the present exemplary embodiment, in at least one of radio wave emitters 4-1 and 4-2, the protection target value is smaller than the normal target value.

The protection target value for the plurality of radio wave emitters 4 is set so that the power consumption distribution in cavity 10a when executing the protection operation is closer to that when executing the normal operation than that when only the electric power target value of protection target radio wave emitter 4 is set to the protection target value. In the present exemplary embodiment, the ratio of the protection target values for radio wave emitters 4-1 and 4-2 is equal to the ratio of the normal target values for radio wave emitters 4-1 and 4-2.

Setting of protection target values will be described in further detail. The protection operation (temperature-based protection operation) includes determining each of the protection target values for the plurality of radio wave emitters 4 so that all the temperature measurement values fall below the protection temperature threshold value Tth1.

As an example, in the temperature-based protection operation, a value obtained by reducing a predetermined amount from each of the current electric power target values for radio wave emitters 4-1 and 4-2 is set as the protection target value. In each of radio wave emitters 4-1 and 4-2, the predetermined amount is based on the normal target value. As an example, the predetermined amount may be obtained by multiplying the normal target value by a predetermined rate. The predetermined rate may be, for example, 0.1 (=10%).

As an example, the protection target value is determined according to the following Eq. (2).

$$\text{?} \qquad [ Eq . 2 ]$$

$$\text{?} \text{indicates text missing or illegible when filed}$$

In Eq. (2), the variable x represents the ordinal number of arbitrary radio wave emitter 4. The variable x is an integer greater than or equal to 1 (x is 2 in the present exemplary embodiment). That is, Pfnx represents the protection target value for the x-th one of radio wave emitters 4. Px represents the current electric power target value for the x-th one of radio wave emitters 4. The variable d represents a predetermined rate.

Referring to FIG. 15, at time t20, electric power target value P1 for radio wave emitter 4-1 is 250 W and electric power target value P2 for radio wave emitter 4-2 is 200 W. As described previously, normal target value Pf1 for radio wave emitter 4-1 is 250 W and normal target value Pf1 for radio wave emitter 4-2 is 200 W.

At the stage of switching the operation of radio wave emitting device 1 from the normal operation to the protection operation, electric power target value P1 for radio wave emitter 4-1 and electric power target value P2 for radio wave emitter 4-2 are equal to normal target values Pf1 and Pf2, respectively. Therefore, protection target value Pfn1 for radio wave emitter 4-1 is 225 (=250×(1−0.1)). Protection target value Pfn2 for radio wave emitter 4-2 is 180 (=200×(1−0.1)).

As described above, protection target value Pfn1 is 225 W, and protection target value Pfn2 is 180 W. The ratio of protection target values Pfn1 and Pfn2 (for example, 225:180=5:4) is equal to the ratio of normal target values Pf1 and Pf2 (for example, 250:200=5:4).

Because protection target value Pfn1 is set to 225 W and protection target value Pfn2 is set to 180 W, electric power target value P1 decreases from 250 W to 225 W and electric power target value P2 decreases from 250 W to 180 W.

As illustrated in FIG. 14, the temperature-based protection operation includes determining whether or not temperature measurement values T1 and T2 are lower than previous ones (step S42). It is expected that reducing electric power target values P1 and P2 at step S41 decreases temperature measurement values T1 and T2.

However, it requires a certain amount of time until temperature measurement values T1 and T2 lower after electric power target values P1 and P2 have reduced. For this reason, controller 6 confirms at step S42 that temperature measurement values T1 and T2 have reduced.

As illustrated in FIG. 14, if the determination result at step S42 is NO, controller 6 repeats the process of step S42. When the determination result at step S32 turns to YES, controller 6 allows the process to proceed to step S32.

At step S43, controller 6 determines whether or not the time variation of temperature measurement values T1 and T2 is within a predetermined range at a predetermined time. Step S43 is performed in order to determine whether or not temperature measurement values T1 and T2 are stable.

Note that the predetermined time and the predetermined range in step S43 are set appropriately based on whether or not temperature measurement values T1 and T2 are stable. Specifically, the predetermined time is from 1 second to 1 minute (for example, 10 seconds). The predetermined range is within 10 degrees (for example, within 3 degrees).

If the determination result at step S43 is NO, controller 6 repeats the process of step S43. When the determination result at step S43 turns to YES, controller 6 allows the process to proceed to step S44. At step S44, controller 6 determines whether or not at least one of temperature measurement values T1 and T2 is higher than or equal to temperature target value Tth2 (see FIG. 15).

Temperature target value Tth2 is the target value of the temperature target value Tth2 of signal amplifier 3 during execution of the temperature-based protection operation. Temperature target value Tth2 is lower than protection temperature threshold value Tth1. As an example, temperature target value Tth2 is 90 degrees.

If the determination result at step S43 is YES, controller 6 returns the process to step S41 and sets the protection target values for radio wave emitters 4-1 and 4-2 again.

As illustrated in FIG. 15, from time t21 to t22, both the time variations of temperature measurement values T1 and T2 are within a predetermined range at a predetermined time (the determination result at step S43 in FIG. 14 is YES). However, temperature measurement value T1 is higher than or equal to temperature target value Tth2 (the determination result at step S44 is YES). Accordingly, controller 6 returns the process to step S41.

At time t22, electric power target value P1 is 225 W and electric power target value P2 is 180 W. Therefore, protection target value Pfn1 for radio wave emitter 4-1 is 203 (=225×(1−0.1)). Protection target value Pfn2 for radio wave emitter 4-2 is 162 (=180×(1−0.1)).

Thus, the protection operation (temperature-based protection operation) includes decreasing each of the protection target values for the plurality of radio wave emitters 4 in a step-by-step manner until temperature measurement values T1 and T2 fall below temperature target value Tth2. This enables the temperature of signal amplifier 3 to be lower than temperature target value Tth2, to protect signal amplifier 3.

If the determination result at step S44 is NO, controller 6 allows the process to proceed to step S45. At step S45, controller 45 determines whether or not all of temperature measurement values T1 and T2 fall below or equal to return temperature threshold value Tth3 (see FIG. 15). Return temperature threshold value Tth3 is lower than protection temperature threshold value Tth1. As an example, return temperature threshold value Tth3 is 80 degrees.

If the determination result at step S45 is YES, controller 6 returns the process to step S31 to switch the operation of radio wave emitting device 1 from the protection operation to the normal operation. If the determination result at step S45 is NO, controller 6 returns the process to step S44.

As illustrated in FIG. 15, from time t23 to t24, the time variations of temperature measurement values T1 and T2 are within a predetermined range at a predetermined time (the determination result at step S43 in FIG. 14 is YES). At time t24, temperature measurement values T1 and T2 are lower than temperature target value Tth2 (the determination result at step S44 in FIG. 14 is NO). Temperature measurement values T1 and T2 are further lower than temperature target value Tth3 (the determination result at step S45 in FIG. 14 is YES).

Therefore, controller 6 switches the operation of radio wave emitting device 1 from the protection operation to the normal operation. Accordingly, controller 6 returns the process to step S31 of FIG. 13, and sets the electric power target values for the plurality of radio waves emitted from the plurality of radio wave emitters 4 to the respective normal target values for the plurality of radio wave emitters 4.

As a result, before and after time t24, electric power target value P1 increases from 203 W to 250 W, and traveling-wave electric power measurement value Pfd2 increases from 162 W to 200 W.

Thus, if controller 6 determines that at least one of temperature measurement values T1 and T2 is higher than or equal to protection temperature threshold value Tth1 during execution of the normal operation, controller 6 switches the operation of radio wave emitting device 1 from the normal operation to the protection operation. For one or both of protection target radio wave emitter 4, which corresponds to signal amplifier 3 for which protection is necessary, and radio wave emitter 4 of the plurality of radio wave emitters 4 other than protection target radio wave emitter 4, the protection target value is lower than the normal target value.

The protection target value for the plurality of radio wave emitters 4 is set so that the power consumption distribution in cavity 10a when executing the protection operation is closer to that when executing the normal operation than that when only the electric power target value of protection target radio wave emitter 4 is set to the protection target value. As a result, it becomes possible to improve stability of the processing of irradiation target 20 while protecting signal amplifier 3.

In the present exemplary embodiment, controller 6 is able to execute two types of protection operations. Controller 6 continues one of the protection operations that is being executed even if the condition for executing the other one of the protection operations is satisfied while executing the one of the protection operations. More precisely, controller 6 selectively executes the temperature-based protection operation and the electric power-based protection operation as the protection operation.

Specifically, if controller 6 determines that at least one of temperature measurement values is higher than or equal to the protection temperature threshold value during execution of the normal operation, controller 6 switches the operation of radio wave emitting device 1 from the normal operation to the temperature-based protection operation. When the operation of radio wave emitting device 1 is switched from the temperature-based protection operation to the electric power-based protection operation during execution of the temperature-based protection operation, protection of signal amplifier 3 may rather be unstable.

In such a case, controller 6 allows the temperature-based protection operation to continue even if at least one of reflected-wave electric power measurement values becomes higher than or equal to the protection electric power threshold value during execution of the temperature-based protection operation. This serves to reduce the possibility of unstable protection of signal amplifier 3.

If controller 6 determines that at least one of reflected-wave electric power measurement values is higher than or equal to the protection electric power threshold value during execution of the normal operation, controller 6 switches the operation of radio wave emitting device 1 from the normal operation to the electric power-based protection operation. When the operation of radio wave emitting device 1 is switched from the electric power-based protection operation to the temperature-based protection operation during execution of the electric power-based protection operation, protection of signal amplifier 3 may rather be unstable.

In such a case, controller 6 allows the electric power-based protection operation to continue even if at least one of temperature measurement values becomes higher than or equal to the protection temperature threshold value during execution of the electric power-based protection operation. This serves to reduce the possibility of unstable protection of signal amplifier 3.

There may be a possibility that at least one of temperature measurement values, and at least one of reflected-wave electric power measurement values, both reach higher than or equal to the threshold values during execution of the normal operation. In such a case, controller 6 executes one of the temperature-based protection operation and the electric power-based protection operation that has a higher priority order.

The priority order between the temperature-based protection operation and the electric power-based protection operation may be determined as appropriate. For example, in the temperature-based protection operation, the protection target value is lowered in order to resolve the condition in which the temperature measurement value is higher than or equal to the threshold value. On the other hand, in the electric power-based protection operation, the protection target value is lowered in order to resolve the condition in which the reflected-wave electric power measurement value is higher than or equal to the threshold value.

A change in the protection target value is reflected in a change in the reflected-wave electric power measurement value more quickly than in a change in the temperature measurement value. Therefore, the electric power-based protection operation is able to protect signal amplifier 3 more quickly than the temperature-based protection operation.

However, the temperature-based protection operation is capable of dealing with not only the increase in the temperature measurement value due to the reflected-wave electric power but also increases in the temperature measurement value due to other factors, such as an increase in the ambient temperature. On the other hand, the electric power-based protection operation is based on the reflected-wave electric power measurement value and is therefore difficult to deal with other factors, such as an increase in the ambient temperature. Nevertheless, the electric power-based protection operation is easier to control than is the temperature-based protection operation.

### 1.1.2 Advantageous Effects, Etc

Radio wave emitting device 1 includes cavity 10a, signal generator 2, a plurality of signal amplifiers 3 (3-1 and 3-2), a plurality of radio wave emitters 4 (4-1 and 4-2), a plurality of measurers (5-1 and 5-2), and controller 6.

Cavity 10a accommodates irradiation target 20. Signal generator 2 generates high frequency signals. The plurality of signal amplifiers 3 amplify the high frequency signals to output a plurality of amplified high frequency signals. The plurality of radio wave emitters 4 emit a plurality of radio waves into cavity 10a based on the plurality of amplified high frequency signals.

The plurality of measurers 5 output one or both of temperature measurement values (T1 and T2) each indicating the temperatures of the plurality of signal amplifiers 3 and reflected-wave electric power measurement values (Prd1 and Prd2) each indicating the electric power of the reflected waves flowing back through the plurality of radio wave emitters 4. Controller 6 controls signal generator 2 and the plurality of signal amplifiers 3.

Controller 6 switches the operation of radio wave emitting device 1 from a normal operation to a protection operation when it determines, during execution of the normal operation, that protection is necessary for at least one of the plurality of signal amplifiers 3 based on one or both of the temperature measurement value and the reflected-wave power measurement value.

The normal operation includes setting electric power target value P1 for one of the radio waves to normal target value Pf1 for radio wave emitter 4-1, and electric power target value P2 for another one of the radio waves to normal target value Pf2 for radio wave emitter 4-2. The protection operation includes setting electric power target value P1 for one of the radio waves to protection target value Pfn1 for radio wave emitter 4-1, and electric power target value P2 for another one of the radio waves to protection target value Pfn2 for radio wave emitter 4-2.

That is, the normal operation includes setting electric power target values for the plurality of radio waves to respective normal target values for the plurality of radio wave emitters. The protection operation includes setting electric power target values for the plurality of radio waves to respective protection target values for the plurality of radio wave emitters.

For one or both of protection target radio wave emitter 4, which corresponds to signal amplifier 3 for which protection is necessary, and radio wave emitter 4 of the plurality of radio wave emitters 4 other than protection target radio wave emitter 4, the protection target value is lower than the normal target value.

The protection target value for the plurality of radio wave emitters 4 is set so that the power consumption distribution in cavity 10a is closer to that when executing the normal operation than that when only the electric power target value of protection target radio wave emitter 4 is set to the protection target value. This configuration makes it possible to improve stability of the processing of irradiation target 20 while protecting signal amplifier 3.

In radio wave emitting device 1, the ratio of protection target value Pfn1 for radio wave emitter 4-1 and protection target value Pfn2 for radio wave emitter 4-2 is equal to the ratio of normal target value Pf1 for radio wave emitter 4-1 and normal target value Pf2 for radio wave emitter 4-2. This configuration can bring the power consumption distribution in cavity 10a when executing the protection operation closer to the power consumption distribution in cavity 10a when executing the normal operation.

In radio wave emitting device 1, the protection operation includes determining a protection target value for a radio wave emitter corresponding to the maximum reflected-wave electric power measurement value of reflected-wave electric power measurement values Prd1 and Prd2.

The protection operation further includes determining a protection target value for a radio wave emitter other than the protection target radio wave emitter, based on the ratio of normal target values Pf1 and Pf2 and on the protection target value for a radio wave emitter of radio wave emitters 4-1 and 4-2 that corresponds to the reflected-wave electric power measurement value. This configuration makes it possible to improve stability of the processing of irradiation target 20 while protecting signal amplifier 3.

In radio wave emitting device 1, the protection operation includes decreasing protection target value Pfn1 for radio wave emitter 4-1 and protection target value Pfn2 for radio wave emitter 4-2 in a step-by-step manner, until all temperature measurement values T1 and T2 fall below temperature target value Tth2. This configuration makes it possible to improve stability of the processing of irradiation target 20 while protecting signal amplifier 3.

In radio wave emitting device 1, controller 6 determines that protection is necessary for a signal amplifier corresponding to one of temperature measurement values that is higher than or equal to a protection temperature threshold value. Protection target value Pfn1 for radio wave emitter 4-1 is set so that temperature measurement value T1 during execution of the protection operation is lower than protection temperature threshold value Tth1. Protection target value Pfn2 for radio wave emitter 4-2 is set so that temperature measurement value T2 during execution of the protection operation is lower than protection temperature threshold value Tth1.

This configuration can reduce the possibility that the actual temperatures of signal amplifiers 3-1 and 3-2 become higher than or equal to protection temperature threshold value Tth1 during the protection operation.

In radio wave emitting device 1, if controller 6 determines that all of temperature measurement values T1 and T2 are lower than or equal to return temperature threshold value Tth3 during execution of the protection operation, controller 6 switches the operation of radio wave emitting device 1 from the protection operation to the normal operation. Return temperature threshold value Tth3 is lower than protection temperature threshold value Tth1. This configuration can reduce the possibility of switching the operation of radio wave emitting device 1 to the protection operation again immediately after switching from the protection operation to the normal operation.

In radio wave emitting device 1, controller 6 determines that protection is necessary for a signal amplifier corresponding to, of the reflected-wave electric power measurement values, a reflected-wave electric power measurement value that is higher than or equal to the protection electric power threshold value. Protection target value Pfn1 for radio wave emitter 4-1 is set so that reflected-wave electric power measurement value Prd1 during execution of the protection operation is lower than protection electric power threshold value Pth. Protection target value Pfn2 for radio wave emitter 4-2 is set so that reflected-wave electric power measurement value Prd2 during execution of the protection operation is lower than protection electric power threshold value Pth.

This configuration can reduce the possibility that the actual electric power of the reflected waves of signal amplifiers 4-1 and 4-2 becomes higher than or equal to protection electric power threshold value Pth during the protection operation.

In radio wave emitting device 1, controller 6 switches the operation of radio wave emitting device 1 from the protection operation to the normal operation if controller 6 determines that all of reflected-wave electric power measurement values Prd1 and Prd2 are lower than the return electric power threshold value of radio wave emitters 4-1 and 4-2. In radio wave emitters 4-1 and 4-2, the return electric power threshold value is set so that the ratio of the protection electric power threshold value Pth to each of the traveling-wave electric power measurement values, which are the electric power values of the plurality of radio waves, is smaller during execution of the protection operation than that during execution of the normal operation. This configuration can reduce the possibility of switching the operation of radio wave emitting device 1 to the protection operation again immediately after switching from the protection operation to the normal operation.

In radio wave emitting device 1, controller 6 selectively executes the temperature-based protection operation and the electric power-based protection operation as the protection operation. If controller 6 determines that at least one of temperature measurement values T1 and T2 is higher than or equal to protection temperature threshold value Tth1 during execution of the normal operation, controller 6 switches the operation of radio wave emitting device 1 from the normal operation to the temperature-based protection operation.

If controller 6 determines that at least one of reflected-wave electric power measurement values Prd1 and Prd2 is higher than or equal to protection electric power threshold value Pth during execution of the normal operation, controller 6 switches the operation of radio wave emitting device 1 from the normal operation to the electric power-based protection operation.

The temperature-based protection operation includes determining protection target value Pfn1 for radio wave emitter 4-1 and protection target value Pfn2 for radio wave emitter 4-2 so that all temperature measurement values T1 and T2 fall below protection temperature threshold value Tth1.

The electric power-based protection operation includes determining protection target value Pfn1 for radio wave emitter 4-1 and protection target value Pfn2 for radio wave emitter 4-2 so that all reflected-wave electric power measurement values Prd1 and Prd2 fall below protection electric power threshold value Pth.

Controller 6 determines, during execution of the normal operation, whether or not at least one of temperature measurement values T1 and T2 has reached higher than or equal to protection temperature threshold value Tth1. Controller 6 determines, during execution of the normal operation, whether or not at least one of reflected-wave electric power measurement values Prd1 and Prd2 is higher than or equal to protection electric power threshold value Pth.

If both of these determination results are YES, controller 6 switches the operation of radio wave emitting device 1 from the normal operation to one of the temperature-based protection operation and the electric power-based protection operation that has a higher priority order. This configuration can select and set a protection operation that is to be executed preferentially from the temperature-based protection operation and the electric power-based protection operation.

In radio wave emitting device 1, controller 6 continues the temperature-based protection operation even if at least one of reflected-wave electric power measurement values Prd1 and Prd2 has become protection electric power threshold value Pth during execution of the temperature-based protection operation. In such a case, controller 6 allows the electric power-based protection operation to continue even if at least one of temperature measurement values becomes higher than or equal to the protection temperature threshold value during execution of the electric power-based protection operation.

This configuration can reduce the possibility that protection to signal amplifier 3 becomes unstable due to switching from one of the temperature-based protection operation and the electric power-based protection operation to another.

In another aspect, radio wave emitting device 1 includes cavity 10, signal generator 2, signal amplifiers 3-1 and 3-2, radio wave emitters 4-1 and 4-2, measurers 5-1 and 5-2, and controller 6.

Cavity 10a accommodates irradiation target 20. Signal generator 2 generates high frequency signals. The plurality of signal amplifiers 3 amplify the high frequency signals to output a plurality of amplified high frequency signals. The plurality of radio wave emitters 4 emit a plurality of radio waves into cavity 10a based on the plurality of amplified high frequency signals. The plurality of measurers 5 output one or both of temperature measurement values T1 and T2 respectively indicating the temperatures of signal amplifiers 3-1 and 3-2, and reflected-wave electric power measurement values Prd1 and Prd2 indicating the electric power of the reflected waves flowing back through radio wave emitters 4-1 and 4-2. Controller 6 controls signal generator 2 and signal amplifiers 3-1 and 3-2.

Controller 6 switches the operation of radio wave emitting device 1 from the normal operation to the protection operation when it determines, during execution of the normal operation, that protection is necessary for at least one of signal amplifiers 3-1 and 3-2 based on one or both of temperature measurement values T1 and T2 and reflected-wave electric power measurement values Prd1 and Prd2.

The normal operation includes setting electric power target value P1 for one of the radio waves to normal target value Pf1 for radio wave emitter 4-1, and electric power target value P2 for another one of the radio waves to normal target value Pf2 for radio wave emitter 4-2. The protection operation includes setting electric power target value P1 for one of the radio waves to protection target value Pfn1 for radio wave emitter 4-1, and electric power target value P2 for another one of the radio waves to protection target value Pfn2 for radio wave emitter 4-2.

For radio wave emitters 4-1 and 4-2, the protection target value is lower than the normal target value. The ratio of protection target value Pfn1 for radio wave emitter 4-1 and protection target value Pfn2 for radio wave emitter 4-2 is equal to the ratio of normal target value Pf1 for radio wave emitter 4-1 and normal target value Pf2 for radio wave emitter 4-2. This configuration makes it possible to improve stability of the processing of irradiation target 20 while protecting signal amplifier 3.

### 1.2 Second Exemplary Embodiment

### 1.2.1 Configuration

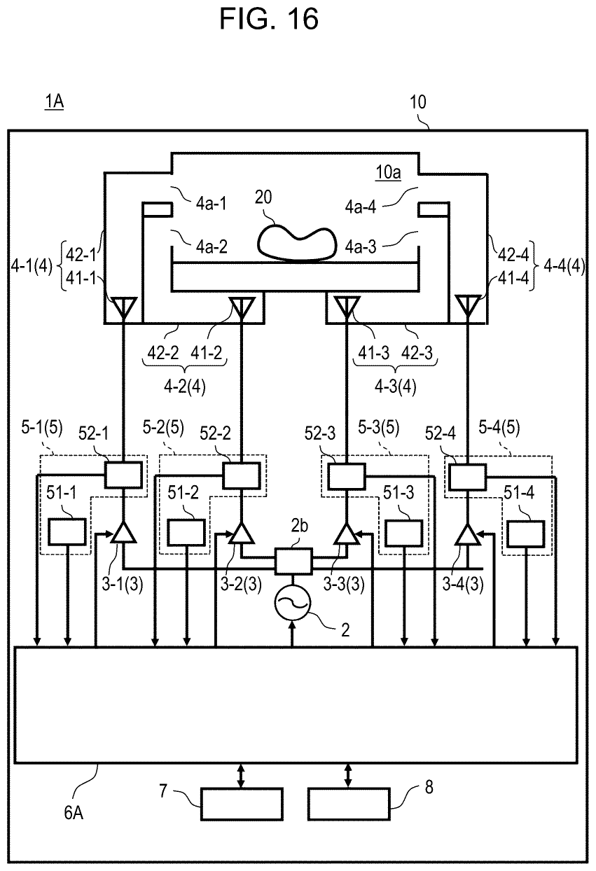

FIG. 16 is a schematic view illustrating radio wave emitting device 1A according to a second exemplary embodiment of the present disclosure. As illustrated in FIG. 16, radio wave emitting device 1A includes signal generator 2, electric power distributor 2b, signal amplifiers 3-1, 3-2, 3-3, and 3-4, radio wave emitters 4-1, 4-2, 4-3, and 4-4, measurers 5-1, 5-2, 5-3, and 5-4, controller 6A, memory storage 7, input/output unit 8, and housing 10.

Signal amplifiers 3-1 to 3-4 mean the first one of signal amplifiers 3 to the fourth one of signal amplifiers 3, respectively. This also applies to radio wave emitters 4-1 to 4-4 as well as measurers 5-1 to 5-4. Hereinafter, signal amplifiers 3-1 to 3-4 are collectively referred to as a plurality of signal amplifiers 3. Radio wave emitters 4-1 to 4-4 are collectively referred to as a plurality of radio wave emitters 4. Measurers 5-1 to 5-4 are collectively referred to as a plurality of measurers 5.

On the other hand, when simply signal amplifier 3 is referred to, it means one of signal amplifiers 3-1 to 3-4. When simply radio wave emitter 4 is referred to, it means either of radio wave emitters 4-1 to 4-4. When simply measurer 5 is referred to, it means one of measurers 5-1 to 5-4.

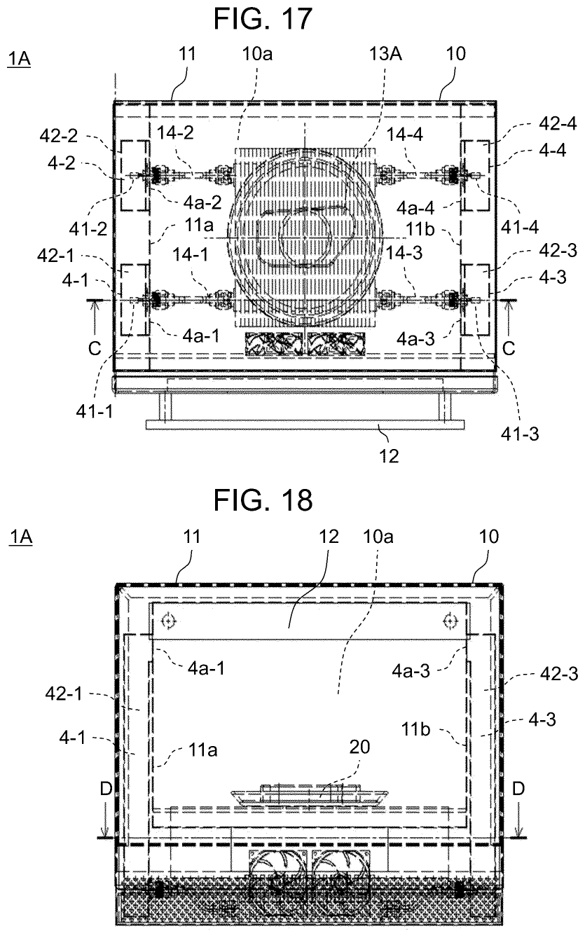

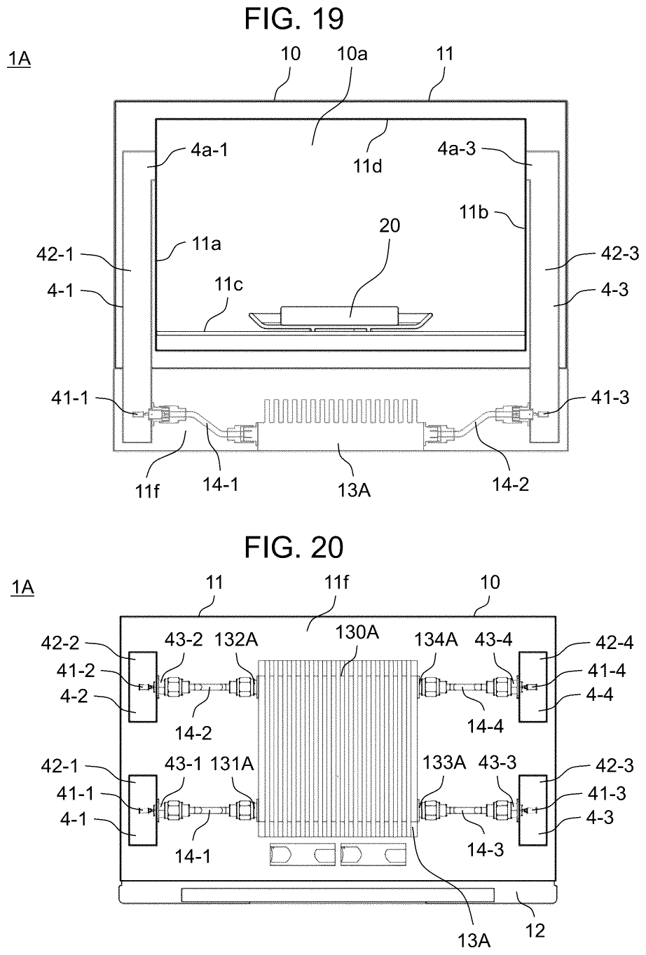

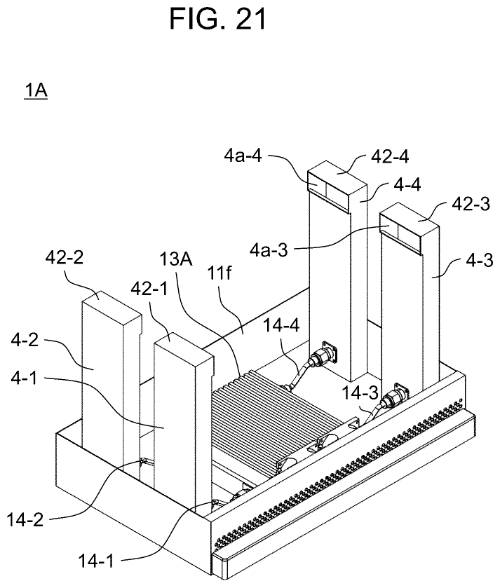

FIG. 17 is a plan view of radio wave emitting device 1A, schematically illustrating the internal structure of housing 10. FIG. 18 is a front view of radio wave emitting device 1A, schematically illustrating the internal structure of housing 10. FIG. 19 is a cross-sectional view taken along line C-C in FIG. 17. FIG. 20 is a cross-sectional view taken along line D-D in FIG. 18. FIG. 21 is a perspective view illustrating radio wave emitting device 1A, a portion of which is omitted.

As illustrated in FIGS. 19, 20, and 21, main body 11 includes housing space 11f below cavity 10a. Housing space 11f accommodates high frequency signal generating unit 13A. High frequency signal generating unit 13A includes housing 130A in a substantially rectangular parallelepiped shape. Housing 130A accommodates signal generator 2, signal amplifiers 3-1 to 3-4, measurers 5-1 to 5-4, controller 6A, and memory storage 7.

High frequency signal generating unit 13A includes first port 131A, second port 132A, third port 133A, and fourth port 134A. First ports 131 to 134A output amplified high frequency signals sent from signal amplifiers 3-1 to 3-4, respectively. First port 131A, second port 132A, third port 133A, and fourth port 134A are, for example, coaxial connectors to which coaxial cables can be connected.

Referring to FIG. 16, signal generator 2 generates high frequency signals. Electric power distributor 2b is connected between signal generator 2 and each of signal amplifiers 3-1 to 3-4. Electric power distributor 2a supplies high frequency signals sent from signal generator 2 to signal amplifiers 3-1 to 3-4.

Signal amplifier 3 amplifies the high frequency signals sent from signal generator 2. Each of signal amplifiers 3-1 to 3-4 amplifies the supplied high frequency signals and outputs amplified high frequency signals.

Signal amplifiers 3-1 to 3-4 are connected to first port 131A, second port 132A, third port 133A, and fourth port 134A (for all, FIG. 20), respectively. Thus, first port 131A outputs the amplified high frequency signal from signal amplifier 3-1. Second port 132A outputs the amplified high frequency signal from signal amplifier 3-2. Third port 133A outputs the amplified high frequency signal from signal amplifier 3-3. Forth port 134A outputs the amplified high frequency signal from signal amplifier 3-4.

The plurality of radio wave emitters 4 emit a plurality of radio waves into cavity 10a based on the amplified high frequency signals from the plurality of signal amplifiers 3. Specifically, radio wave emitter 4-1 emits a radio wave into cavity 10a based on the amplified high frequency signal from signal amplifier 3-1. Radio wave emitter 4-2 emits a radio wave into cavity 10a based on the amplified high frequency signal from signal amplifier 3-2.

Radio wave emitter 4-3 emits a radio wave into cavity 10a based on the amplified high frequency signal from signal amplifier 3-3. Radio wave emitter 4-4 emits a radio wave into cavity 10a based on the amplified high frequency signal from signal amplifier 3-4.

Radio wave emitter 4-1 includes antenna 41-1 and waveguide 42-1. Radio wave emitter 4-2 includes antenna 41-2 and waveguide 42-2. Radio wave emitter 4-3 includes antenna 41-3 and waveguide 42-3. Radio wave emitter 4-4 includes antenna 41-4 and waveguide 42-4.

As illustrated in FIG. 20, radio wave emitter 4-1 includes connector 43-1 connected to antenna 41-1. Radio wave emitter 4-2 includes connector 43-2 connected to antenna 41-2. Radio wave emitter 4-3 includes connector 43-3 connected to antenna 41-3. Radio wave emitter 4-4 includes connector 43-4 connected to antenna 41-4.

Connector 43-1 is connected to first port 131A via connecting cable 14-1. Connector 43-2 is connected to first port 132A via connecting cable 14-2. Connector 43-3 is connected to first port 133A via connecting cable 14-3. Connector 43-4 is connected to first port 134A via connecting cable 14-4.

In this way, antennas 41-1 to 41-4 are connected to signal amplifiers 3-1 and 3-4, respectively. Antennas 41-1 to 41-4 emit radio waves based on amplified high frequency signals from signal amplifiers 3-1 to 3-4, respectively.

Connectors 43-1, 43-2, 43-3, and 43-4 are, for example, coaxial connectors to which coaxial cables can be connected, and connecting cables 14-1, 14-2, 14-3, and 14-4 are coaxial cables.

As illustrated in FIG. 16, waveguides 42-1 to 42-4 guide the radio waves emitted from antennas 41-1 to 41-4, respectively, into cavity 10a. As illustrated in FIGS. 18, 19, and 21, waveguides 42-1 to 42-4 each have a rectangular parallelepiped shape extending in a vertical direction.

As illustrated in FIG. 19, first ends (specifically, lower ends) of waveguides 42-1 to 42-4 are disposed inside housing space 11f.

As illustrated in FIG. 20, antennas 41-1 to 41-4 are disposed inside waveguides 42-1 to 42-4 near the first ends, respectively.

Connectors 43-1 to 43-4 are disposed outside waveguides 42-1 to 42-4 near the first ends, respectively.

Antennas 41-1 to 41-4 are connected to connectors 43-1 to 43-4, respectively. Openings 4a-1, 4a-2, 4a-3, and 4a-4 are formed in the side surfaces of second ends (specifically, upper ends) of waveguides 42-1 to 42-4, respectively.

Opening 4a-1 is disposed in left wall surface 11a of main body 11 to communicate cavity 10a and waveguide 42-1 with each other. This allows the radio wave emitted from antenna 41-1 to be emitted through waveguide 42-1 and opening 4a-1 into cavity 10a.

Opening 4a-2 is disposed in left wall surface 11a of main body 11 to communicate cavity 10a and waveguide 42-2 with each other. This allows the radio wave emitted from antenna 41-2 to be emitted through waveguide 42-2 and opening 4a-2 into cavity 10a.

Opening 4a-3 is disposed in right wall surface 11b of main body 11 to communicate cavity 10a and waveguide 42-3 with each other. This allows the radio wave emitted from antenna 41-3 to be emitted through waveguide 42-3 and opening 4a-3 into cavity 10a.

Opening 4a-4 is disposed in right wall surface 11b of main body 11 to communicate cavity 10a and waveguide 42-4 with each other. This allows the radio wave emitted from antenna 41-4 to be emitted through waveguide 42-4 and opening 4a-4 into cavity 10a.

As illustrated in FIG. 16, the plurality of measurers 5 output temperature measurement values, which indicate the temperatures of the plurality of signal amplifiers 3, and a plurality of reflected-wave electric power measurement values. Specifically, measurers 5-1 to 5-4 output temperature measurement values that indicate the temperatures of signal amplifiers 3-1 to 3-4, respectively.

Also, measurers 5-1 to 5-4 respectively output reflected-wave electric power measurement values that indicate the electric power of the reflected waves flowing back through radio wave emitters 4-1 to 4-4.

More specifically, measurers 5-1 to 5-4 include temperature measurers 51-1, 51-2, 51-3, and 51-4, respectively. Measurers 5-1 to 5-4 further include electric power measurers 52-1, 52-2, 52-3, and 52-4, respectively.

Temperature measurers 51-1 to 51-4 each include temperature sensors disposed near signal amplifiers 3-1 to 3-4, respectively. This allows temperature measurers 51-1 to 51-4 to measure the temperatures of signal amplifiers 3-1 to 3-4, respectively. Temperature measurers 51-1 to 51-4 output temperature measurement values that indicate the temperatures of signal amplifiers 3-1 to 3-4, respectively, to controller 6A.

Electric power measurer 52-1 measures the electric power of the amplified high frequency signal (traveling wave) that is supplied from signal amplifier 3-1 to radio wave emitter 4-1 for the purpose of emitting radio waves into cavity 10a. Electric power measurer 52-2 measures the electric power of the amplified high frequency signal (traveling wave) that is supplied from signal amplifier 3-2 to radio wave emitter 4-2 for the purpose of emitting radio waves into cavity 10a.

Electric power measurer 52-3 measures the electric power of the amplified high frequency signal (traveling wave) that is supplied from signal amplifier 3-3 to radio wave emitter 4-3 for the purpose of emitting radio waves into cavity 10a. Electric power measurer 52-4 measures the electric power of the amplified high frequency signal (traveling wave) that is supplied from signal amplifier 3-4 to radio wave emitter 4-4 for the purpose of emitting radio waves into cavity 10a.

Electric power measurers 52-1 to 52-4 output the traveling-wave electric power measurement values, which indicate the measured electric power of the traveling waves, to controller 6A.

In addition, electric power measurer 52-1 measures the electric power of a reflected wave that flows back toward signal amplifier 3-1 through radio wave emitter 4-1. Electric power measurer 52-2 measures the electric power of a reflected wave that flows back toward signal amplifier 3-2 through radio wave emitter 4-2.

Electric power measurer 52-3 measures the electric power of a reflected wave that flows back toward signal amplifier 3-3 through radio wave emitter 4-3. Electric power measurer 52-4 measures the electric power of a reflected wave that flows back toward signal amplifier 3-4 through radio wave emitter 4-4.

Electric power measurers 52-1 to 52-4 output the reflected-wave electric power measurement values, which indicate the measured electric power of the reflected waves, to controller 6.

Controller 6A controls signal generator 2 and the plurality of signal amplifiers 3. This allows radio wave emitting device 1A to emit a plurality of radio waves from radio wave emitters 4-1 to 4-4 into cavity 10a, to heat irradiation target 20.

As in the first exemplary embodiment, controller 6A selectively executes a normal operation and a protection operation. The protection operation includes a temperature-based protection operation and an electric power-based protection operation. Controller 6A executes the operations shown in the flowcharts of FIGS. 9, 10, 13, and 14.

The electric power-based protection operation of controller 6A will be described briefly. As illustrated in FIG. 9, controller 6A first executes the normal operation (step S11).

Although not shown in the drawings, P1, P2, P3 and P4 respectively represent the electric power target values for the plurality of radio waves emitted from radio wave emitters 4-1 to 4-4 in the following description. In FIG. 1, Pf1, Pf2, Pf3, and Pf4 represent respective electric power target values for radio wave emitters 4-1 to 4-4. Prd1 to Prd4 represent reflected-wave electric power measurement values that are measured by measurers 5-1 to 5-4, respectively.

The normal operation includes setting electric power target values P1 to P4 to normal target values Pf1 to Pf4, respectively. As an example, normal target values Pf1 to Pf4 are 250 W, 200 W, 300 W, and 150 W, respectively.

Controller 6A determines, during execution of the normal operation, whether or not at least one of reflected-wave electric power measurement values Prd1, Prd2, Prd3, and Prd4 is higher than or equal to protection electric power threshold value Pth.

For example, it is assumed that reflected-wave electric power measurement values Prd1 to Prd4 are 90 W, 80 W, 100 W, and 90 W, respectively. When protection electric power threshold value Pth is 100 W, controller 6A determines that reflected-wave electric power measurement value Prd3 is higher than or equal to protection electric power threshold value Pth (YES in step S12). Accordingly, controller 6A switches the operation of radio wave emitting device 1A from the normal operation to the protection operation (electric power-based protection operation) (step S13).

Pf1, Pf2, Pf3, and Pf4 are respective protection target values for the plurality of radio waves emitted from radio wave emitters 4-1 to 4-4, respectively. As illustrated in FIG. 10, the electric power-based protection operation includes setting electric power target values P1 to P4 to the respective protection target values for radio wave emitters 4-1 to 4-4 (step S21). Protection target values Pfn1 to Pfn4 are determined according to the foregoing Eq. (1).

When reflected-wave electric power measurement values Prd1 to Prd4 are 90 W, 80 W, 100 W, and 90 W, respectively, radio wave emitter 4 of the plurality of radio wave emitters 4 that corresponds to the maximum reflected-wave electric power measurement value is radio wave emitter 4-3. Accordingly, protection target value Pfn3 for radio wave emitter 4-3 is determined based on reflected-wave electric power measurement value Prd3 of radio wave emitter 4-3.

For example, it is assumed that target value Prpt for the electric power of the reflected wave during the protection operation is 80 W and traveling-wave electric power measurement value Pfd3 of radio wave emitter 4-3 is equal to normal target value Pf3. In this case, protection target value Pfn3 for radio wave emitter 4-3 is 240 (=80*(300/100)*(300/300)).

As mentioned previously, normal target values Pf1 to Pf4 are 250 W, 200 W, 300 W, and 150 W, respectively. Therefore, protection target value Pfn1 for radio wave emitter 4-1 is 200 (=80*(300/100)*(250/300)).

Protection target value Pfn2 for radio wave emitter 4-2 is 160 (=80*(300/100)*(200/300)). Protection target value Pfn4 for radio wave emitter 4-4 is 120 (=80*(300/100)*(150/300)).

Thus, protection target value Pfn1 is 200 W, protection target value Pfn2 is 160 W, protection target value Pfn3 is 240 W, and protection target value Pfn4 is 120 W.

The ratio of protection target values Pfn1, Pfn2, Pfn3, and Pfn4 (for example, 200:160:240:120=5:4:6:3) is equal to the ratio of normal target values Pf1, Pf2, Pf3, and Pf4 (for example, 250:200:300:150=5:4:6:3).

As illustrated in FIG. 10, the protection operation includes determining whether or not each of the reflected electric power ratios of radio wave emitters 4-1 to 4-4 is lower than end threshold value Rth (step S22). If the determination result at step S22 is YES, controller 6 switches the operation of radio wave emitting device 1A from the protection operation to the normal operation.

Thus, if controller 6 determines that at least one of reflected-wave electric power measurement values Prd1 to Prd4 is higher than or equal to protection electric power threshold value Pth during execution of the normal operation, controller 6A switches the operation of radio wave emitting device 1A from the normal operation to the protection operation.

Controller 6A determines that protection is necessary for signal amplifier 3 that corresponds to a reflected-wave electric power measurement value that is higher than or equal to the protection electric power threshold value Pth. For one or both of protection target radio wave emitter 4, which corresponds to signal amplifier 3 for which protection is necessary, and radio wave emitter 4 of the plurality of radio wave emitters 4 (4-1 to 4-4) other than protection target radio wave emitter 4, the protection target value is lower than the normal target value.

The protection target value for the plurality of radio wave emitters is set so that the power consumption distribution in cavity 10a when executing the protection operation is closer to that when executing the normal operation than that when only the electric power target value of protection target radio wave emitter 4 is set to the protection target value. As a result, it becomes possible to improve stability of the processing of irradiation target 20 while protecting signal amplifier 3.

The temperature-based protection operation of controller 6A will be described briefly. As illustrated in FIG. 13, controller 6A first executes the normal operation (step S31). The normal operation includes setting electric power target values for the plurality of radio waves emitted from radio wave emitters 4-1 to 4-4 to respective normal target values Pf1 to Pf4 for radio wave emitters 4-1 to 4-4. As an example, normal target values Pf1 to Pf4 are 250 W, 200 W, 300 W, and 150 W, respectively.

Although not shown in the drawings, T1 to T4 respectively represent the temperature measurement values measured by measurers 5-1 to 5-4 in the following description. Controller 6A determines, during execution of the normal operation, whether or not at least one of temperature measurement values T1, T2, T3, and T4 is higher than or equal to protection temperature threshold value Tth1 (step S32). If the determination result at step S32 is NO, controller 6A repeats the process of step S32.

When the determination result at step S32 turns to YES, controller 6A switches the operation of radio wave emitting device 1A from the normal operation to the protection operation (temperature-based protection operation) (step S33).

As illustrated in FIG. 14, the protection operation (temperature-based protection operation) includes setting electric power target values P1 to P4 for the plurality of radio waves emitted from radio wave emitters 4-1 to 4-4 to protection target values Pfn1 to Pfn4 for radio wave emitters 4-1 to 4-4 (step S41). Protection target values Pfn1 to Pfn4 are determined according to the foregoing Eq. (2).

Normal target values Pf1 to Pf4 are 250 W, 200 W, 300 W, and 150 W, respectively. Therefore, when the operation of radio wave emitting device 1A is switched from the normal operation to the protection operation (temperature-based protection operation), electric power target values P1 to P4 are 250 W, 200 W, 300 W, and 150 W, respectively.

For example, it is assumed that predetermined rate d is 0.1. In this case, protection target value Pfn1 for radio wave emitter 4-1 is 225 (=250×(1−0.1)). Protection target value Pfn2 for radio wave emitter 4-2 is 180 (=200×(1−0.1)). Protection target value Pfn3 for radio wave emitter 4-3 is 270 (=300×(1−0.1)). Protection target value Pfn4 for radio wave emitter 4-4 is 135 (=150×(1−0.1)).

Thus, protection target value Pfn1 is 225 W, protection target value Pfn2 is 180 W, protection target value Pfn3 is 270 W, and protection target value Pfn4 is 135 W.

The ratio of protection target values Pfn1, Pfn2, Pfn3, and Pfn4 (for example, 225:180:270:135=5:4:6:3) is equal to the ratio of normal target values Pf1, Pf2, Pf3, and Pf4 (for example, 250:200:300:150=5:4:6:3).

As illustrated in FIG. 14, in the temperature-based protection operation, controller 6A determines whether or not all of temperature measurement values T1 to T4 have decreased from the previous ones (step S42). If the determination result at step S42 is NO, controller 6A repeats the process of step S42.

When the determination result at step S42 turns to YES, controller 6A determines at step S43 whether or not the time variation of temperature measurement values T1 to T4 is within a predetermined range within a predetermined time.

If the determination result at step S43 is NO, controller 6A repeats the process of step S43. When the determination result at step S43 turns to YES, controller 6A allows the process to proceed to step S44. At step S44, controller 6A determines whether or not at least one of temperature measurement values T1 to T4 is higher than or equal to temperature target value Tth2.

If the determination result at step S44 is YES, controller 6A returns the process to step S41, to set protection target values Pfn1 to Pfn4 again. Electric power target values P1 to P4 are 225 W, 180 W, 270 W, and 135 W, respectively.

In this case, protection target value Pfn1 is 203 (=225×(1−0.1)). Protection target value Pfn2 is 162 (=180×(1−0.1)). Protection target value Pfn3 is 243 (=270×(1−0.1)). Protection target value Pfn4 is 122 (=135×(1−0.1)).

Thus, the protection operation (temperature-based protection operation) includes decreasing each of protection target values Pfn1 to Pfn4 for the plurality of radio wave emitters 4 (4-1 to 4-4) in a step-by-step manner until all of temperature measurement values T1 and T2 fall below temperature target value Tth2.

Controller 6A determines whether or not at least one of temperature measurement values T1 to T4 is higher than or equal to temperature target value Tth2 (step S44). If the determination result at step S44 is NO, in other words, if all of temperature measurement values T1 to T4 fall below temperature target value Tth2, controller 6 allows the process to proceed to step S45.

At step S45, controller 6A determines whether or not all of temperature measurement values T1 to T4 fall below or equal to return temperature threshold value Tth3. If the determination result at step S45 is YES, controller 6A returns the process to step S31 to switch the operation of radio wave emitting device 1A from the protection operation to the normal operation. If the determination result at step S45 is NO, controller 6 returns the process to step S44.

Thus, if controller 6A determines that at least one of temperature measurement values T1 to T4 is higher than or equal to protection temperature threshold value Tth1 during execution of the normal operation, controller 6A switches the operation of radio wave emitting device 1A from the normal operation to the protection operation.

Controller 6A determines that protection is necessary for signal amplifier 3 corresponding to a reflected-wave electric power measurement value that is higher than or equal to protection temperature threshold value Tth1. For one or both of protection target radio wave emitter 4, which corresponds to signal amplifier 3 for which protection is necessary, and radio wave emitter 4 of the plurality of radio wave emitters 4 (4-1 to 4-4) other than protection target radio wave emitter 4, the protection target value is lower than the normal target value.

The protection target value for the plurality of radio wave emitters 4 is set so that the power consumption distribution in cavity 10a when executing the protection operation is closer to that when executing the normal operation than that when only the electric power target value of protection target radio wave emitter 4 is set to the protection target value. As a result, it becomes possible to improve stability of the processing of irradiation target 20 while protecting signal amplifier 3.

In radio wave emitting device 1 according to the first exemplary embodiment, radio waves are emitted through each of openings 4a-1 and 4a-2. On the other hand, in radio wave emitting device 1A according to the present exemplary embodiment, radio waves are emitted through each of openings 4a-1, 4a-2, 4a-3, and 4a-4.

As a result, radio wave emitting device 1A has more feasible power consumption distribution patterns than radio wave emitting device 1. Therefore, radio wave emitting device 1A is able to perform a wider variety of processing to irradiation target 20 than radio wave emitting device 1.

### 1.2.2 Advantageous Effects, Etc

Radio wave emitting device 1A includes cavity 10a, signal generator 2, a plurality of signal amplifiers 3 (3-1 to 3-4), a plurality of radio wave emitters 4 (4-1 to 4-4), a plurality of measurers (5-1 to 5-4), and controller 6A.

Cavity 10a accommodates irradiation target 20. Signal generator 2 generates high frequency signals. The plurality of signal amplifiers 3 amplify the high frequency signals to output a plurality of amplified high frequency signals. The plurality of radio wave emitters 4 emit a plurality of radio waves into cavity 10a based on the plurality of amplified high frequency signals.

The plurality of measurers 5 output one or both of temperature measurement values (T1 to T4) indicating the temperatures of the plurality of signal amplifiers 3 and reflected-wave electric power measurement values (Prd1 to Prd4) indicating the electric power of the reflected waves flowing back through the plurality of radio wave emitters 4. Controller 6A controls signal generator 2 and the plurality of signal amplifiers 3.

Controller 6A switches the operation of radio wave emitting device 1A from a normal operation to a protection operation when it determines, during execution of the normal operation, that protection is necessary for at least one of the plurality of signal amplifiers 3 based on one or both of the temperature measurement value and the reflected-wave power measurement value.

The normal operation includes setting electric power target values P1 to P4 for a plurality of radio waves to respective normal target values Pf1 to Pf4 for radio wave emitters 4-1 to 4-4. The protection operation includes setting electric power target values for the plurality of radio waves to respective protection target values Pfn1 to Pfn4 for radio wave emitters 4-1 to 4-4.

For one or both of protection target radio wave emitter 4, which corresponds to signal amplifier 3 for which protection is necessary, and radio wave emitter 4 of the plurality of radio wave emitters 4 other than protection target radio wave emitter 4, the protection target value is lower than the normal target value.

The protection target value for the plurality of radio wave emitters 4 is set so that the power consumption distribution in cavity 10a is closer to that when executing the normal operation than that when only the electric power target value of protection target radio wave emitter 4 is set to the protection target value. This configuration makes it possible to improve stability of the processing of irradiation target 20 while protecting signal amplifier 3.

### 1.3 Third Exemplary Embodiment

### 1.3.1 Configuration

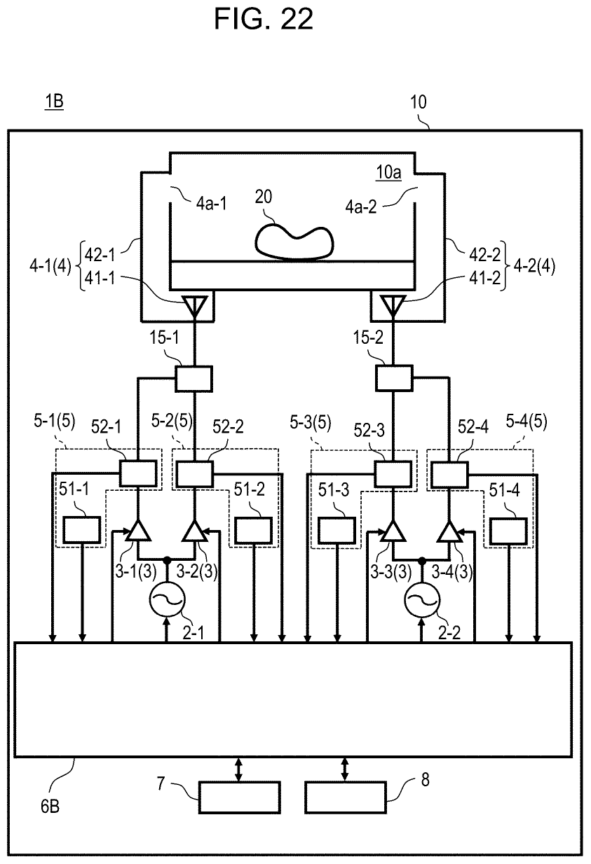

FIG. 22 is a schematic view illustrating radio wave emitting device 1B according to a third exemplary embodiment of the present disclosure. As illustrated in FIG. 22, radio wave emitting device 1B includes signal generators 2-1 and 2-2, signal amplifiers 3-1, 3-2, 3-3, and 3-4, electric power combiners 15-1 and 15-2, radio wave emitters 4-1 and 4-2, measurers 5-1, 5-2, 5-3, and 5-4, controller 6B, memory storage 7, input/output unit 8, and housing 10.

Signal generators 2-1 and 2-2 mean the first one of signal generators 2 and the second one of signal generators 2, respectively. This also applies to electric power combiners 15-1 and 15-2. Signal amplifiers 3-1 to 3-4 mean the first one of signal amplifiers 3 to the fourth one of signal amplifiers 3, respectively. This also applies to radio wave emitters 4-1 to 4-4 as well as measurers 5-1 to 5-4.

Hereinafter, signal generators 2-1 and 2-2 are collectively referred to as a plurality of signal generators 2. Signal amplifiers 3-1 to 3-4 are collectively referred to as a plurality of signal amplifiers 3. Electric power combiners 15-1 and 15-2 are collectively referred to as a plurality of electric power combiners 15. Radio wave emitters 4-1 and 4-2 are collectively referred to as a plurality of radio wave emitters 4. Measurers 5-1 to 5-4 are collectively referred to as a plurality of measurers 5.

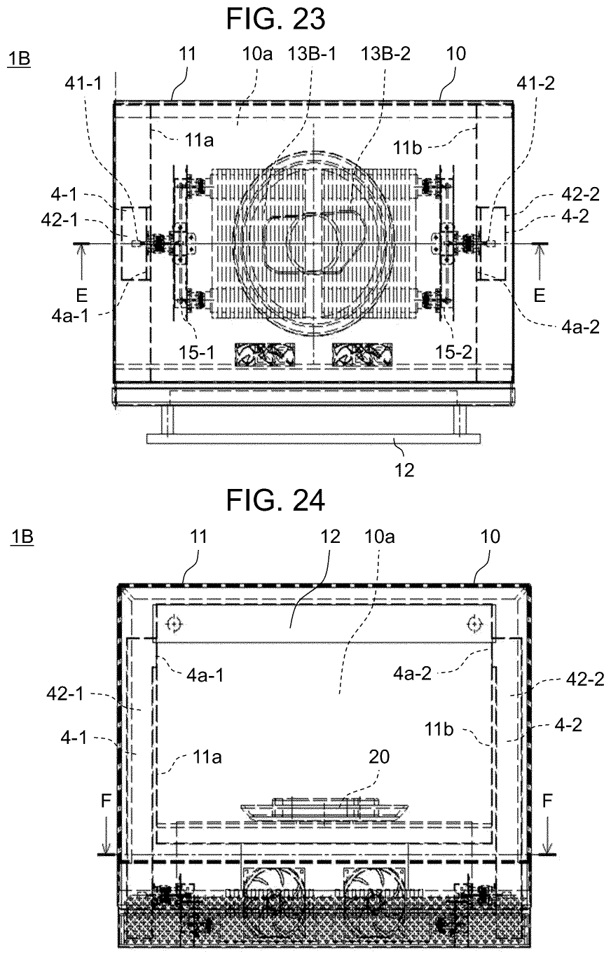

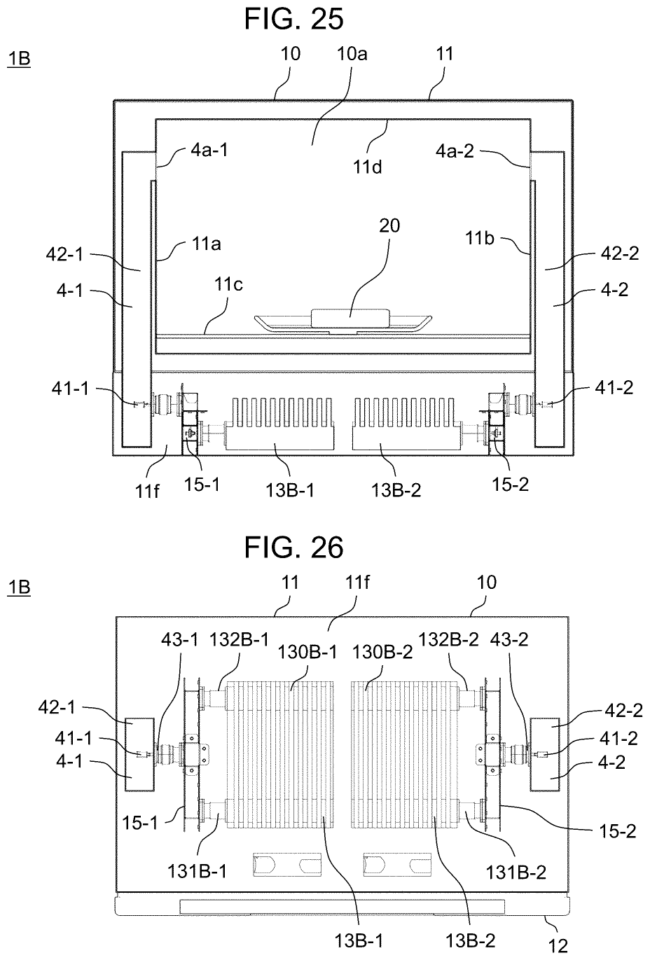

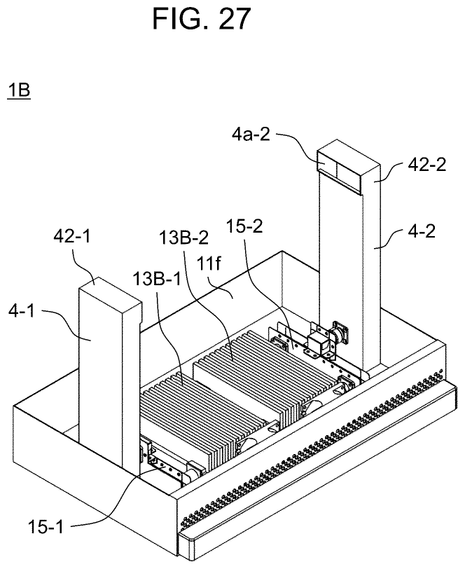

FIG. 23 is a plan view of radio wave emitting device 1B, schematically illustrating the internal structure of housing 10. FIG. 24 is a front view of radio wave emitting device 1B, schematically illustrating the internal structure of housing 10. FIG. 25 is a cross-sectional view taken along line E-E in FIG. 23. FIG. 26 is a cross-sectional view taken along line F-F in FIG. 24. FIG. 27 is a perspective view illustrating radio wave emitting device 1B, a portion of which is omitted.

As illustrated in FIGS. 25, 26, and 27, main body 11 includes housing space 11f below cavity 10a. Housing space 11f accommodates high frequency signal generating units 13B-1 and 13B-2. High frequency signal generating units 13B-1 and 13B-2 respectively include housings 130B-1 and 130B2 each in a substantially rectangular parallelepiped shape.

Housing 130B-1 accommodates signal generator 2-1, signal amplifiers 3-1 and 3-2, and measurers 5-1 and 5-2. Housing 130B-2 accommodates signal generator 2-2, signal amplifiers 3-3 and 3-4, and measurers 5-3 and 5-4.

High frequency signal generating unit 13B-1 includes first port 131B-1 and second port 132B-1. First port 131B-1 outputs the amplified high frequency signal from signal amplifier 3-1. Second port 132B-1 outputs the amplified high frequency signal from signal amplifier 3-2.

First port 131B-1 and second port 132B-1 are, for example, coaxial connectors to which coaxial cables can be connected.

High frequency signal generating unit 13B-2 includes first port 131B-2 and second port 132B-2. First port 131B-2 outputs the amplified high frequency signal from signal amplifier 3-3. Second port 132B-2 outputs the amplified high frequency signal from signal amplifier 3-4. First port 131B-2 and second port 132B-2 are, for example, coaxial connectors to which coaxial cables can be connected.

As illustrated in FIG. 22, signal generator 2-1 generates high frequency signals, and supplies the high frequency signals to signal amplifiers 3-1 and 3-2. Signal generator 2-2 generates high frequency signals, and supplies the high frequency signals to signal amplifiers 3-3 and 3-4. Each of signal amplifiers 3-1 to 3-4 amplifies the supplied high frequency signals and outputs amplified high frequency signals.

Signal amplifiers 3-1 and 3-2 are connected to first port 131B-1 and second port 132B-1 (for both, see FIG. 26), respectively. Signal amplifiers 3-3 and 3-4 are connected to first port 131B-2 and second port 132B-2 (for both, see FIG. 26), respectively.

Accordingly, first port 131B-1 outputs the amplified high frequency signal from signal amplifier 3-1. Second port 132B-1 outputs the amplified high frequency signal from signal amplifier 3-2. First port 131B-2 outputs the amplified high frequency signal from signal amplifier 3-3. Second port 132B-2 outputs the amplified high frequency signal from signal amplifier 3-4.

Radio wave emitter 4-1 emits radio waves into cavity 10a based on the amplified high frequency signals from signal amplifiers 3-1 and 3-2. Radio wave emitter 4-2 emits radio waves into cavity 10a based on the amplified high frequency signals from signal amplifiers 3-3 and 3-4.

Radio wave emitter 4-1 includes antenna 41-1 and waveguide 42-1. Radio wave emitter 4-2 includes antenna 41-2 and waveguide 42-2.

As illustrated in FIG. 26, radio wave emitter 4-1 includes connector 43-1 connected to antenna 41-1. Connector 43-1 is connected to first port 131B-1 and second port 132B-1 via electric power combiner 15-1. Electric power combiner 15-1 combines the amplified high frequency signals from first port 131B-1 and second port 132B-1 and outputs the combined signal to connector 43-1.

In this way, antenna 41-1 is connected to signal amplifiers 3-1 and 3-2 via electric power combiner 15-1. Antenna 41-1 emits radio waves based on the signal obtained by combining the amplified high frequency signals from signal amplifiers 3-1 and 3-2. Connector 43-1 is a coaxial connector that is connectable to electric power combiner 15-1.

As illustrated in FIG. 26, radio wave emitter 4-2 includes connector 43-2 connected to antenna 41-2. Connector 43-2 is connected to first port 131B-2 and second port 132B-2 via electric power combiner 15-2. Electric power combiner 15-2 combines the amplified high frequency signals from first port 131B-2 and second port 132B-2 and outputs the combined signal to connector 43-2.

In this way, antenna 41-2 is connected to signal amplifiers 3-3 and 3-4 via electric power combiner 15-2. Antenna 41-2 emits radio waves based on the signal obtained by combining the amplified high frequency signals from signal amplifiers 3-3 and 3-4.

Connector 43-2 is a coaxial connector that is connectable to electric power combiner 15-2.

As illustrated in FIG. 22, waveguides 42-1 and 42-2 guide the radio waves emitted from antennas 41-1 and 41-2, respectively, into cavity 10a. As illustrated in FIGS. 24, 25, and 27, waveguides 42-1 and 42-2 each have a rectangular parallelepiped shape extending in a vertical direction of housing 10.

As illustrated in FIG. 25, first ends (specifically, lower ends) of waveguides 42-1 and 42-2 are disposed inside housing space 11f. As illustrated in FIG. 26, antennas 41-1 and 41-2 are disposed inside waveguides 42-1 and 42-2 near the first ends, respectively.

Connectors 43-1 and 43-2 are disposed outside waveguides 42-1 and 42-2 near the first ends, respectively. Antennas 41-1 and 41-2 are connected to connectors 43-1 and 43-2, respectively.

As illustrated in FIG. 25, openings 4a-1 and 4a-2 are formed in the side surfaces of second ends (specifically, upper ends) of waveguides 42-1 and 42-2, respectively. Opening 4a-1 of waveguide 42-1 is disposed in left wall surface 11a of main body 11 to communicate cavity 10a and waveguide 42-1 with each other. This allows the radio wave emitted from antenna 41-1 to be emitted through waveguide 42-1 and opening 4a-1 into cavity 10a.

Opening 4a-2 is disposed in right wall surface 11b of main body 11 to communicate cavity 10a and waveguide 42-2 with each other. This allows the radio wave emitted from antenna 41-2 to be emitted through waveguide 42-2 and opening 4a-2 into cavity 10a.

As illustrated in FIG. 22, the plurality of measurers 5 output temperature measurement values, which indicate the temperatures of the plurality of signal amplifiers 3, and a plurality of reflected-wave electric power measurement values. Specifically, measurers 5-1 to 5-4 output temperature measurement values that indicate the temperatures of signal amplifiers 3-1 to 3-4, respectively.

Also, measurers 5-1 and 5-2 output reflected-wave electric power measurement values that indicate the electric power of the reflected waves flowing back through radio wave emitter 4-1. Measurers 5-1 and 5-4 output reflected-wave electric power measurement values that indicate the electric power of the reflected waves flowing back through radio wave emitter 4-2.

More specifically, measurer 5-1 includes temperature measurer 51-1 and electric power measurer 52-1. Measurer 5-2 includes temperature measurer 51-2 and electric power measurer 52-2. Measurer 5-3 includes temperature measurer 51-3 and electric power measurer 52-3. Measurer 5-4 includes temperature measurer 51-4 and electric power measurer 52-4.

Temperature measurers 51-1 to 51-4 each include temperature sensors disposed near signal amplifiers 3-1 to 3-4, respectively. This allows temperature measurers 51-1 to 51-4 to measure the temperatures of signal amplifiers 3-1 to 3-4, respectively. Temperature measurers 51-1 to 51-4 output temperature measurement values that indicate the temperatures of signal amplifiers 3-1 to 3-4, respectively, to controller 6B.

Electric power measurer 52-1 is disposed between signal amplifier 3-1 and electric power combiner 15-1, and electric power measurer 52-2 is disposed between signal amplifier 3-2 and electric power combiner 15-1. Electric power measurers 52-1 and 52-2 measure the electric power of the amplified high frequency signals from signal amplifiers 3-1 and 3-2, respectively. The amplified high frequency signals from signal amplifiers 3-1 and 3-2 are the signals that form the basis of radio waves (traveling waves) that are emitted from radio wave emitter 4-1 into cavity 10a.

The total value of electric power measured by electric power measurers 52-1 and 52-2 corresponds to the electric power of the traveling waves emitted from radio wave emitter 4-1. Specifically, in measurers 5-1 and 5-2, electric power measurers 52-1 and 52-2 output traveling-wave electric power measurement values, which indicate the electric power of the traveling waves emitted from radio wave emitter 4-1, to controller 6B.

Electric power measurers 52-1 and 52-2 measure the electric power of the reflected waves flowing back through radio wave emitter 4-1. Because electric power combiner 15-1 is disposed between radio wave emitter 4-1 and electric power measurers 52-1 and 52-2, each of the reflected-wave electric power measurement values measured by electric power measurers 52-1 and 52-2 is half of the actual electric power of the reflected waves flowing back through radio wave emitter 4-1.

Therefore, the total of the reflected-wave electric power measurement values measured by electric power measurers 52-1 and 52-2 corresponds to the electric power of the reflected waves flowing back through radio wave emitter 4-1. Specifically, in measurers 5-1 and 5-2, electric power measurers 52-1 and 52-2 output reflected-wave electric power measurement values, which indicate the electric power of the reflected waves flowing back through radio wave emitter 4-1, to controller 6B.

Electric power measurer 52-3 is disposed between signal amplifier 3-3 and electric power combiner 15-2, and electric power measurer 52-4 is disposed between signal amplifier 3-4 and electric power combiner 15-2. Electric power measurers 52-3 and 52-4 measure the electric power of the amplified high frequency signals from signal amplifiers 3-3 and 3-4, respectively. The amplified high frequency signals from signal amplifiers 3-3 and 3-4 are the signals that form the basis of radio waves (traveling waves) that are emitted from radio wave emitter 4-1 into cavity 10a.

The total value of electric power measured by electric power measurers 52-3 and 52-4 corresponds to the electric power of the traveling waves emitted from radio wave emitter 4-2. Specifically, in measurers 5-3 and 5-4, electric power measurers 52-3 and 52-4 output traveling-wave electric power measurement values, which indicate the electric power of the traveling waves emitted from radio wave emitter 4-2, to controller 6B.

Electric power measurers 52-3 and 52-4 measure the electric power of the reflected waves flowing back through radio wave emitter 4-2. Because electric power combiner 15-2 is disposed between radio wave emitter 4-2 and electric power measurers 52-3 and 52-4, each of the reflected-wave electric power measurement values measured by electric power measurers 52-3 and 52-4 is half of the actual electric power of the reflected waves flowing back through radio wave emitter 4-2.

Therefore, the total of the reflected-wave electric power measurement values measured by electric power measurers 52-3 and 52-4 corresponds to the electric power of the reflected waves flowing back through radio wave emitter 4-2. Specifically, in measurers 5-3 and 5-4, electric power measurers 52-3 and 52-4 output reflected-wave electric power measurement values, which indicate the electric power of the reflected waves flowing back through radio wave emitter 4-3, to controller 6B.

Controller 6B controls signal generator 2 and signal amplifiers 3-1 to 3-4 to cause radio wave emitters 4-1 and 4-2 to emit a plurality of radio waves into cavity 10a.

As in the first and second exemplary embodiments, controller 6B selectively executes a normal operation and a protection operation. The protection operation includes a temperature-based protection operation and an electric power-based protection operation. Controller 6B executes the operations shown in the flowcharts of FIGS. 9, 10, 13, and 14.

In the present exemplary embodiment, two signal amplifiers 3 correspond to one radio wave emitter 4. Specifically, signal amplifiers 3-1 and 3-2 correspond to radio wave emitter 4-1, and signal amplifiers 3-3 and 3-4 correspond to radio wave emitter 4-2. In the normal operation and the protection operation, the control conditions of a plurality of signal amplifiers 3 corresponding to one radio wave emitter 4 are the same. In other words, a plurality of signal amplifiers 3 corresponding to one radio wave emitter 4 are treated as one signal amplifier 3.

The electric power-based protection operation of controller 6B will be described briefly. As illustrated in FIG. 9, controller 6B first executes the normal operation (step S11).

The normal operation includes setting electric power target values P1 and P2 for the plurality of radio waves emitted from radio wave emitters 4-1 and 4-2 to respective normal target values Pf1 to Pf4 for radio wave emitters 4-1 to 4-4. As an example, normal target values Pf1 and Pf2 are 250 W and 200 W, respectively.

Controller 6B determines, during execution of the normal operation, whether or not at least one of reflected-wave electric power measurement values Prd1 and Prd2 that are measured by measurers 5-1 to 5-4 is higher than or equal to protection electric power threshold value Pth. Note that reflected-wave electric power measurement value Prd1 is the total of the values measured by measurers 5-1 and 5-2, and reflected-wave electric power measurement value Prd2 is the total of the values measured by measurers 5-3 and 5-4. For example, it is assumed that reflected-wave electric power measurement values Prd1 and Prd2 are 100 W and 80 W, respectively. When protection electric power threshold value Pth is 100 W, controller 6B determines that reflected-wave electric power measurement value Prd1 is higher than or equal to protection electric power threshold value Pth (YES in step S12). Accordingly, controller 6B switches the operation of radio wave emitting device 1B from the normal operation to the protection operation (electric power-based protection operation) (step S13).

As illustrated in FIG. 9, the electric power-based protection operation includes setting electric power target values for the plurality of radio waves emitted from radio wave emitters 4-1 and 4-2 to protection target values Pfn1 and Pfn2 for radio wave emitters 4-1 and 4-2 (step S21). Protection target values Pfn1 and Pfn2 are determined according to the foregoing Eq. (1).

When reflected-wave electric power measurement values Prd1 and Prd2 are 100 W and 80 W, respectively, radio wave emitter 4 of the plurality of radio wave emitters 4 that corresponds to the maximum reflected-wave electric power measurement value is radio wave emitter 4-1. Accordingly, protection target value Pfn1 for radio wave emitter 4-1 is determined based on reflected-wave electric power measurement value Prd1 of radio wave emitter 4-1.

For example, it is assumed that target value Prpt for the electric power of the reflected wave during the protection operation is 80 W and traveling-wave electric power measurement value Pfd1 of radio wave emitter 4-1 is equal to normal target value Pf1. In this case, protection target value Pfn3 for radio wave emitter 4-3 is 200 (=80*(250/100)*(250/250)).

As mentioned previously, normal target values Pf1 and Pf2 are 250 W and 200 W, respectively. Therefore, protection target value Pfn2 for radio wave emitter 4-2 is 160 (=80*(250/100)*(200/250)).

As described above, protection target value Pfn1 is 200 W, and protection target value Pfn2 is 160 W. The ratio of protection target values Pfn1 and Pfn2 (for example, 200:160=5:4) is equal to the ratio of normal target values Pf1 and Pf2 (for example, 250:200=5:4).

As illustrated in FIG. 10, the protection operation includes determining whether or not each of the reflected electric power ratios of radio wave emitters 4-1 and 4-2 is lower than end threshold value Rth (step S22). If the determination result at step S22 is YES, controller 6B switches the operation of radio wave emitting device 1B from the protection operation to the normal operation.

Thus, if controller 6B determines that at least one of reflected-wave electric power measurement values Prd1 and Prd2 is higher than or equal to protection electric power threshold value Pth during execution of the normal operation, controller 6B switches the operation of radio wave emitting device 1 from the normal operation to the protection operation.

Controller 6B determines that protection is necessary for signal amplifier 3 that corresponds to a reflected-wave electric power measurement value that is higher than or equal to the protection electric power threshold value Pth. For one or both of protection target radio wave emitter 4, which corresponds to signal amplifier 3 for which protection is necessary, and radio wave emitter 4 of the plurality of radio wave emitters 4 (4-1 and 4-2) other than protection target radio wave emitter 4, the protection target value is lower than the normal target value.

The protection target value for the plurality of radio wave emitters is set so that the power consumption distribution in cavity 10a when executing the protection operation is closer to that when executing the normal operation than that when only the electric power target value of protection target radio wave emitter 4 is set to the protection target value. As a result, it becomes possible to improve stability of the processing of irradiation target 20 while protecting signal amplifier 3.

The temperature-based protection operation of controller 6B will be described briefly. As illustrated in FIG. 13, controller 6B first executes the normal operation (step S31). The normal operation includes setting electric power target values P1 and P2 for the plurality of radio waves emitted from radio wave emitters 4-1 and 4-2 to respective normal target values Pf1 to Pf4 for radio wave emitters 4-1 to 4-4. As an example, normal target values Pf1 and Pf2 are 250 W and 200 W, respectively.

Controller 6B determines, during execution of the normal operation, whether or not at least one of temperature measurement values T1 to T4 is higher than or equal to protection temperature threshold value Tth1 (step S32). If the determination result at step S32 is NO, controller 6B repeats the process of step S32.

When the determination result at step S32 turns to YES, controller 6B switches the operation of radio wave emitting device 1B from the normal operation to the protection operation (temperature-based protection operation) (step S33).

As illustrated in FIG. 14, the protection operation (temperature-based protection operation) includes setting electric power target values P1 and P2 for the plurality of radio waves emitted from radio wave emitters 4-1 and 4-2 to protection target values Pfn1 and Pfn2 for radio wave emitters 4-1 and 4-2 (step S41). Protection target values Pfn1 and Pfn2 are determined according to the foregoing Eq. (2).

Normal target values Pf1 and Pf2 are 250 W and 200 W, respectively. Therefore, when the operation of radio wave emitting device 1B is switched from the normal operation to the protection operation (temperature-based protection operation), electric power target values P1 and P2 are 250 W and 200 W, respectively.

For example, it is assumed that predetermined rate d is 0.1. In this case, protection target value Pfn1 for radio wave emitter 4-1 is 225 (=250×(1−0.1)). Protection target value Pfn2 for radio wave emitter 4-2 is 180 (=200×(1−0.1)).

As described above, protection target value Pfn1 is 225 W, and protection target value Pfn2 is 180 W. In addition, the ratio of protection target values Pfn1 and Pfn2 (for example, 225:180=5:4) is equal to the ratio of normal target values Pf1 and Pf2 (for example, 250:200).

As illustrated in FIG. 14, in the temperature-based protection operation, controller 6B determines whether or not all of temperature measurement values T1 to T4 have decreased from the previous ones (step S42). If the determination result at step S42 is NO, controller 6B repeats the process of step S42.

When the determination result at step S42 turns to YES, controller 6B determines at step S43 whether or not the time variation of temperature measurement values T1 to T4 is within a predetermined range within a predetermined time.

If the determination result at step S43 is NO, controller 6B repeats the process of step S43. When the determination result at step S43 turns to YES, controller 6B allows the process to proceed to step S44. At step S44, controller 6B determines whether or not at least one of temperature measurement values T1 to T4 is higher than or equal to temperature target value Tth2.

If the determination result at step S44 is YES, controller 6B returns the process to step S41, to set protection target values Pfn1 and Pfn2 again. Electric power target values P1 and P2 are 225 W and 180 W, respectively.

In this case, protection target value Pfn1 is 203 (=225×(1−0.1)). Protection target value Pfn2 is 162 (=180×(1−0.1)).

Thus, the protection operation (temperature-based protection operation) includes decreasing each of protection target values Pfn1 to Pfn4 for the plurality of radio wave emitters 4 (4-1 to 4-4) in a step-by-step manner until all of temperature measurement values T1 and T2 fall below temperature target value Tth2.

Controller 6B determines whether or not at least one of temperature measurement values T1 to T4 is higher than or equal to temperature target value Tth2 (step S44). If the determination result at step S44 is NO, in other words, if all of temperature measurement values T1 to T4 fall below temperature target value Tth2, controller 6B allows the process to proceed to step S45.

At step S45, controller 6B determines whether or not all of temperature measurement values T1 to T4 fall below or equal to return temperature threshold value Tth3. If the determination result at step S45 is YES, controller 6B returns the process to step S31 to switch the operation of radio wave emitting device 1B from the protection operation to the normal operation. If the determination result at step S45 is NO, controller 6 returns the process to step S44.

Thus, if controller 6B determines that at least one of temperature measurement values T1 to T4 is higher than or equal to protection temperature threshold value Tth1 during execution of the normal operation, controller 6B switches the operation of radio wave emitting device 1B from the normal operation to the protection operation.

Controller 6B determines that protection is necessary for signal amplifier 3 corresponding to a reflected-wave electric power measurement value that is higher than or equal to protection temperature threshold value Tth1. For one or both of protection target radio wave emitter 4, which corresponds to signal amplifier 3 for which protection is necessary, and radio wave emitter 4 of the plurality of radio wave emitters 4 (4-1 and 4-2) other than protection target radio wave emitter 4, the protection target value is lower than the normal target value.

The protection target value for the plurality of radio wave emitters 4 is set so that the power consumption distribution in cavity 10a when executing the protection operation is closer to that when executing the normal operation than that when only the electric power target value of protection target radio wave emitter 4 is set to the protection target value. As a result, it becomes possible to improve stability of the processing of irradiation target 20 while protecting signal amplifier 3.

In radio wave emitting device 1 according to the first exemplary embodiment, a plurality of radio waves are output into cavity 10a using one signal generator 2. On the other hand, in radio wave emitting device 1B according to the present exemplary embodiment, a plurality of radio waves are output into cavity 10a using signal generators 2-1 and 2-2.

This allows radio wave emitting device 1B to emit a plurality of radio waves having different frequencies from each other into cavity 10a. As a result, radio wave emitting device 1B has more feasible power consumption distribution patterns than radio wave emitting device 1. Therefore, radio wave emitting device 1B is able to perform a wider variety of processing to irradiation target 20 than radio wave emitting device 1.

In addition, radio wave emitting device 1 according to the first exemplary embodiment emits an amplified high frequency signal from one signal amplifier 3 into cavity 10a from radio wave emitter 4. On the other hand, radio wave emitting device 1B according to the present exemplary embodiment combines amplified high frequency signals from a plurality of signal amplifiers 3 and emits the combined amplified high frequency signals into cavity 10a from one radio wave emitter 4.

This allows radio wave emitting device 1B to have a wider range of electric power target value for radio waves than radio wave emitting device 1. Therefore, radio wave emitting device 1B is able to perform a wider variety of processing to irradiation target 20 than radio wave emitting device 1.

### 1.3.2 Advantageous Effects, Etc

Radio wave emitting device 1B includes cavity 10a, a plurality of signal generators 2 (2-1 and 2-2), a plurality of signal amplifiers 3 (3-1 to 3-4), a plurality of radio wave emitters 4 (4-1 to 4-4), a plurality of measurers (5-1 to 5-4), and controller 6B.

Cavity 10a accommodates irradiation target 20. The plurality of signal generators 2 generate a plurality of high frequency signals. The plurality of signal amplifiers 3 amplify the plurality of high frequency signals to output a plurality of amplified high frequency signals. The plurality of radio wave emitters 4 emit a plurality of radio waves into cavity 10a based on the plurality of amplified high frequency signals. The plurality of measurers 5 output one or both of temperature measurement values (T1 to T4) indicating the temperatures of the plurality of signal amplifiers 3 and reflected-wave electric power measurement values (Prd1 and Prd2) indicating the electric power of the reflected waves flowing back through the plurality of radio wave emitters 4. Controller 6B controls the plurality of signal generators 2 and the plurality of signal amplifiers 3.

Controller 6B switches the operation of radio wave emitting device 1 from the normal operation to the protection operation when controller 6B determines, during execution of the normal operation, that protection is necessary for at least one of the plurality of signal amplifiers 3, based on one or both of the temperature measurement value and the reflected-wave power measurement value.

The normal operation includes setting electric power target values P1 and P2 for a plurality of radio waves to respective normal target values Pf1 and Pf2 for radio wave emitters 4-1 and 4-2. The protection operation includes setting electric power target values P1 and P2 for the plurality of radio waves to respective protection target values Pfn1 and Pfn2 for radio wave emitters 4-1 and 4-2.

For one or both of protection target radio wave emitter 4, which corresponds to signal amplifier 3 for which protection is necessary, and radio wave emitter 4 of the plurality of radio wave emitters 4 other than protection target radio wave emitter 4, the protection target value is lower than the normal target value.

The protection target value for the plurality of radio wave emitters 4 is set so that the power consumption distribution in cavity 10a is closer to that when executing the normal operation than that when only the electric power target value of protection target radio wave emitter 4 is set to the protection target value. This configuration can improve stability of the processing of irradiation target 20 while making it possible to protect signal amplifier 3.

In radio wave emitting device 1B, the controller executes a temperature-based priority protection operation as the protection operation.

The temperature-based priority protection operation includes making each of protection target values for the plurality of radio wave emitters lower than that in the temperature-based protection operation, or causing the plurality of radio wave emitters to stop emitting the plurality of radio waves.

If, during execution of the normal operation, the temperature-based protection operation, or the electric power-based protection operation, the controller determines that at least one of temperature measurement values is higher than or equal to a priority protection temperature threshold value, which is higher than the protection temperature threshold value, the controller switches the operation of the radio wave emitting device to the temperature-based priority protection operation.

In radio wave emitting device 1B, the controller executes an electric power-based priority protection operation as the protection operation.

The electric power-based priority protection operation includes making each of protection target values for the plurality of radio wave emitters lower than that in the electric power-based protection operation or causing the plurality of radio wave emitters to stop emitting the plurality of radio waves.

If, during execution of the normal operation, the temperature-based protection operation, or the electric power-based protection operation, the controller determines that at least one of reflected-wave electric power measurement values is higher than or equal to a priority protection electric power threshold value, which is higher than the protection electric power threshold value, the controller switches the operation of the radio wave emitting device to the electric power-based priority protection operation.

### 2. Modified Examples

Embodiments of the present disclosure are not limited to the first to third exemplary embodiments described above. The first to third exemplary embodiments may be modified in various ways according design and the like as long as the objects of the present disclosure are achieved. Hereinafter, modified examples of the first to third exemplary embodiments will be described.

The modified examples described below may be combined as appropriate. Unless otherwise specifically stated, the following modified examples are applicable to any of the first to third exemplary embodiments.

In the first to third exemplary embodiments, the electric power-based protection operation setts electric power target values for the plurality of radio waves emitted from the plurality of radio wave emitters 4 to respective protection target values for the plurality of radio wave emitters 4 (step S21). The protection target values that have been set in the electric power-based protection operation are kept until the end of the electric power-based protection operation.

In one modified example, the protection target values that have been set in the electric power-based protection operation may be changed as appropriate. For example, there may be cases that, when an electric power target value is changed from a normal target value to a protection target value at the start of the protection operation, the conditions inside cavity 10a deteriorate and consequently the reflected-wave electric power increases.

As an example, the controller may monitor the reflected-wave electric power measurement values for a predetermined period from the time when the protection target values for the plurality of radio wave emitters 4 are set, and based on the monitored results, the controller may reset the protection target values for the plurality of radio wave emitters 4.

When at least one of the reflected-wave electric power measurement values has increased from the previous ones, the controller may reset the protection target values for the plurality of radio wave emitters 4.

In resetting the protection target values, the protection target values may be lowered from the previous ones. For example, in the foregoing Eq. (1), the protection target values may be lowered from the previous ones by lowering target value Prpt for the electric power of reflected waves during the protection operation. Alternatively, all the protection target values for the plurality of radio wave emitters 4 may be lowered by a predetermined rate.

In another example, in the electric power-based protection operation, the controller may monitor the reflected-wave electric power measurement values periodically, and based on the monitored results, the controller may reset the protection target values for the plurality of radio wave emitters 4. When at least one of the reflected-wave electric power measurement values has increased from the previous ones, the controller may reset the protection target values for the plurality of radio wave emitters 4.

In one modified example, the controller may execute a priority protection operation that assumes an event that should be handled with higher priority over the normal protection operations (i.e., the temperature-based protection operation and the electric power-based protection operation). If a condition for executing the priority protection operation is satisfied during execution of a normal protection operation, the controller switches the operation of the radio wave emitting device from the normal protection operation to the priority protection operation.

The priority protection operation includes a temperature-based priority protection operation and an electric power-based priority protection operation.

If the controller determines that at least one of temperature measurement values is higher than or equal to a priority protection temperature threshold value, which is higher than protection temperature threshold value Tth1, the controller executes the temperature-based priority protection operation. For example, the priority protection temperature threshold value may be set based on the temperature at which some effect is highly likely to occur on signal amplifier 3.

The temperature-based priority protection operation includes setting the protection target values for the plurality of radio wave emitters 4 to be lower than those in the temperature-based protection operation, or causing the plurality of radio wave emitters 4 to stop emitting the plurality of radio waves. This makes it possible to protect signal amplifier 3 more quickly than the normal protection operations.

If the controller determines that at least one of reflected-wave electric power measurement values is higher than or equal to a priority protection electric power threshold value, which is higher than protection electric power threshold value Pth, the controller executes the electric power-based priority protection operation. For example, the priority protection electric power threshold value may be set based on the electric power of reflected waves at which some effect is highly likely to occur on signal amplifier 3.

The electric power-based priority protection operation includes setting the protection target values for the plurality of radio wave emitters 4 to be lower than those in the reflected-wave electric power protection operation, or causing the plurality of radio wave emitters 4 to stop emitting the plurality of radio waves. This makes it possible to protect signal amplifier 3 more quickly than the normal protection operations.

In one modified example, the controller may be able to execute the above-described two types of priority protection operations. When this is the case, the controller may continue one of the priority protection operations that is being executed even if, during execution of the one of the protection operations, the condition for executing the other one of the priority protection operations is satisfied.

In the first exemplary embodiment, electric power distributor 2a distribute the output from signal generator 2 to a plurality of paths, in order to supply electric power to the plurality of radio wave emitters 4. However, the present disclosure is not limited to this configuration. For example, the radio wave emitting device may include two signal generators 2. That is, it is also possible that the outputs from the two signal generators 2 may be amplified by signal amplifiers 3-1 and 3-2 and a plurality of amplified high frequency signals may be supplied to the plurality of radio wave emitters 4.

In one modified example, a radio wave emitting device may include one or more signal generators 2, two or more signal amplifiers 3, two or more radio wave emitters 4 and one or more measurers 5.

In one modified example, radio wave emitter 4-1 may not include waveguide 42-1. That is, radio wave emitter 4-1 may include antenna 41-1 disposed inside cavity 10a. This also applies to radio wave emitters 4-2, 4-3, and 4-4.

In one modified example, the locations of respective openings 4a-1 to 4a-4 of waveguides 42-1 to 42-4 are not limited to particular locations. The locations of openings 4a-1 to 4a-4 may be set as appropriate so as to be able to form a desired power consumption distribution within cavity 10a.

In the third exemplary embodiment, measurer 5-1 may include one electric power measurer disposed between radio wave emitter 4-1 and electric power combiner 15-1, in place of electric power measurers 52-1 and 52-2. This also applies to measurer 5-2. In one modified example, measurer 5 may output one of a temperature measurement value, which indicates the temperature of signal amplifier 3, and a reflected-wave electric power measurement value, which indicates the electric power of the reflected wave in radio wave emitter 4. In other words, measurer 5 may include either one of the temperature measurer and the electric power measurer.

In one modified example, the controller may determine whether or not to execute switching between the normal operation and the protection operation based on a reflected electric power ratio obtained from reflected-wave electric power measurement values.

As an example, the controller may determine, during execution of the normal operation, whether or not at least one of reflected electric power ratios based on reflected-wave electric power measurement values Prd1 and Prd2 measured by measurers 5-1 and 5-2 is higher than or equal to a predetermined threshold value. The controller may determine whether or not protection is necessary for at least one of the plurality of signal amplifiers 3 according to the determination result.

Controller 6 may determine that protection is necessary for signal amplifier 3 that corresponds to a reflected electric power ratio that is higher than or equal to a predetermined threshold value.

In the first to third exemplary embodiments, respective protection electric power threshold values Pth are the same for the plurality of radio wave emitters 4. However, when, for example, the plurality of signal amplifiers 3 are different from each other in reflected electric power resistance, all of protection electric power threshold values Pth for the plurality of radio wave emitters 4 may not be the same.

In the first to third exemplary embodiments, respective protection temperature threshold values Tth1 are the same for the plurality of radio wave emitters 4. However, when, for example, the plurality of signal amplifiers 3 are different from each other in temperature resistance, all of protection temperature threshold values Tth1 for the plurality of radio wave emitters 4 may not be the same. This also applies to temperature target value Tth2 and return temperature threshold value Tth3.

In one modified example, the protection operation may be either one of the temperature-based protection operation and the electric power-based protection operation.

In one modified example, the radio wave emitting device may include an additional heating unit. The additional heating unit may be at least one of a radiation heater, such as a sheathed heater, and a radio wave emitter, such as a magnetron.

In the first to third exemplary embodiments, high frequency signal generating unit 13, 13A, or 13B is disposed in housing space 11f below cavity 10a. However, the location of high frequency signal generating unit 13, 13A, 13B may be changed as appropriate. The location for housing the high frequency signal generating unit may be changed depending on the design of main body 11, for example, above, to a side of, or behind cavity 10a.

In the third exemplary embodiment, the total of the electric power of reflected waves that flow back through the plurality of radio wave emitters 4 is compared with protection electric power threshold value Pth. However, the target to be compared with protection electric power threshold value Pth may be changed as appropriate. For example, it is also possible that the electric power of the reflected wave measured by an electric power measurer may be compared with protection electric power threshold value Pth.

It is assumed that there may be cases where the reflected waves flowing back through the plurality of radio wave emitters 4 are not distributed evenly between respective ports due to, for example, electric power that is output from the plurality of signal amplifiers 3 and variations in manufacturing of electric power combiners 15. For this reason, the operation of the radio wave emitting device may be switched from the normal operation to the electric power-based protection operation when at least one of the plurality of reflected waves exceeds a threshold value.

In the third exemplary embodiment, electric power combiner 15-1 combines the electric power that is output from signal amplifiers 3-1 and 3-2 and supplies radio waves to waveguide 42-1 through connector 43-1 connected to antenna 41-1.

In one modified example, electric power combiner 15-1 may be composed of waveguide 42-1. That is, respective antennas connected to first port 131B1 and second port 132B1 may be disposed in waveguide 42-1. When this is the case, radio waves emitted from first port 131B1 and second port 132B1 may be combined within waveguide 42-1, and the combined radio waves may be emitted through opening 4a-1 into cavity 10a.

### INDUSTRIAL APPLICABILITY

The present disclosure is applicable to radio wave emitting devices, such as microwave ovens.

### REFERENCE MARKS IN THE DRAWINGS

1, 1A, 1B radio wave emitting device
2, 2-1, 2-2 signal generator
3, 3-1, 3-2, 3-3, 3-4 signal amplifier
4, 4-1, 4-2, 4-3, 4-4 radio wave emitter
4a-1, 4a-2, 4a-3, 4a-4 opening
5, 5-1, 5-2, 5-3, 5-4 measurer
6, 6A, 6B Controller
7 memory storage
8 input/output unit
10, 130, 130A, 130B-1, 130B-2 housing
10a cavity
11 main body
11a left wall surface
11b right wall surface
11c bottom wall surface
11d top wall surface
11e back wall surface
11f housing space
12 door
14-1, 14-2, 14-3, 14-4 connecting cable
15, 15-1, 15-2 electric power combiner
20 irradiation target
41-1, 41-2, 41-3, 41-4 antenna
42-1, 42-2, 42-3, 42-4 waveguide
43-1, 43-2, 43-3, 43-4 connector
51-1, 51-2, 51-3, 51-4 temperature measurer
52-1, 52-2, 52-3, 52-4 electric power measurer
131, 131A, 131B-1, 131B-2, 132, 132A, 132B, 132B-1, 132B-2, 133A, 134A port

1. A radio wave emitting device comprising:
a cavity configured to accommodate an irradiation target;
one or more signal generators configured to generate one or more high frequency signals;
a signal amplifier configured to amplify the one or more high frequency signals and output a plurality of amplified high frequency signals;
a plurality of radio wave emitters configured to emit a plurality of radio waves into the cavity based on the plurality of amplified high frequency signals;
a plurality of measurers configured to output one or both of (i) temperature measurement values and (ii) reflected-wave electric power measurement values, the temperature measurement values each indicating a temperature of a corresponding one of the plurality of signal amplifiers, and the reflected-wave electric power measurement values each indicating an electric power of a reflected wave flowing back through a corresponding one of the plurality of radio wave emitters; and
a controller configured to control the one or more signal generators and the plurality of signal amplifiers; wherein:
the controller is configured to switch an operation of the radio wave emitting device from a normal operation to a protection operation when the controller determines, during execution of the normal operation, that protection is necessary for at least one of the plurality of signal amplifiers, based on one or both of the temperature measurement values and the reflected-wave power measurement values;
the normal operation includes setting electric power target values for the plurality of radio waves to respective normal target values for the plurality of radio wave emitters;
the protection operation includes setting the electric power target values for the plurality of radio waves to respective protection target values for the plurality of radio wave emitters;
for one or both of a protection target radio wave emitter corresponding to a signal amplifier for which protection is necessary and a radio wave emitter of the plurality of radio wave emitters other than the protection target radio wave emitter, a protection target value is lower than a normal target value; and
the protection target values for the plurality of radio wave emitters are set in such a manner that a power consumption distribution in the cavity when executing the protection operation is closer to that when executing the normal operation than that when only the electric power target value of the protection target radio wave emitter is set to the protection target value.

2. A radio wave emitting device according to claim 1, wherein a ratio of the protection target values for the plurality of radio wave emitters is equal to a ratio of the normal target values for the plurality of radio wave emitters.

3. The radio wave emitting device according to claim 2, wherein:
the protection operation includes determining a protection target value for a radio wave emitter corresponding to a maximum reflected-wave electric power measurement value of reflected-wave electric power measurement values; and
the protection operation includes determining the protection target value for the radio wave emitter other than the protection target radio wave emitter, based on the ratio of the normal target values and on the protection target value for the radio wave emitter of the plurality of radio wave emitters that corresponds to the maximum reflected-wave electric power measurement value.

4. The radio wave emitting device according to claim 2, wherein the protection operation includes decreasing each of the protection target values for the plurality of radio wave emitters in a step-by-step manner until all the temperature measurement values fall below a temperature target value.

5. The radio wave emitting device according to claim 1, wherein:
the controller is configured to determine that protection is necessary for a signal amplifier corresponding to one of the temperature measurement values that is higher than or equal to a protection temperature threshold value; and
the protection target values for the plurality of radio wave emitters are set so that all the temperature measurement values during execution of the protection operation fall below the protection temperature threshold value.

6. The radio wave emitting device according to claim 5, wherein:
the controller is configured to switch the operation of the radio wave emitting device from the protection operation to the normal operation if the controller determines that all the temperature measurement values fall below a return temperature threshold value during execution of the protection operation; and
the return temperature threshold value is lower than the protection temperature threshold value.

7. The radio wave emitting device according to claim 1, wherein:
the controller is configured to determine that protection is necessary for a signal amplifier corresponding to one of the reflected-wave electric power measurement values that is higher than or equal to a protection electric power threshold value; and
the protection target values for the plurality of radio wave emitters are set so that all the reflected-wave electric power measurement values during execution of the protection operation fall below the protection temperature threshold value.

8. The radio wave emitting device according to claim 7, wherein:
the controller is configured to switch the operation of the radio wave emitting device from the protection operation to the normal operation if the controller determines that all the reflected-wave electric power measurement values fall below a return electric power threshold value of the plurality of radio wave emitters during execution of the protection operation; and
in the plurality of radio wave emitters, the return electric power threshold value is set so that a ratio of the protection electric power threshold value to each of traveling-wave electric power measurement values being electric power values of the plurality of radio waves, is smaller during execution of the protection operation than that during execution of the normal operation.

9. The radio wave emitting device according to claim 1, wherein:
the controller is configured to selectively execute a temperature-based protection operation and an electric power-based protection operation as the protection operation;
the controller is configured to switch the operation of the radio wave emitting device from the normal operation to the temperature-based protection operation if the controller determines that at least one of the temperature measurement values is higher than or equal to a protection temperature threshold value during execution of the normal operation;
the controller is configured to switch the operation of the radio wave emitting device from the normal operation to the electric power-based protection operation if the controller determines that at least one of the reflected-wave electric power measurement values is higher than or equal to a protection electric power threshold value during execution of the normal operation;
the temperature-based protection operation includes determining the protection target values for the plurality of radio wave emitters so that all the temperature measurement values fall below the protection temperature threshold value;
the electric power-based protection operation includes determining the protection target values for the plurality of radio wave emitters so that all the reflected-wave electric power measurement values fall below the protection electric power threshold value; and
the controller is configured to switch the operation of the radio wave emitting device from the normal operation to one of the temperature-based protection operation and the electric power-based protection operation that has a higher priority order if the controller determines that at least one of the temperature measurement values is higher than or equal to the protection temperature threshold value and at least one of the reflected-wave electric power measurement values is higher than or equal to the protection electric power threshold value during execution of the normal operation.

10. The radio wave emitting device according to claim 9, wherein:
the controller is configured to continue the temperature-based protection operation even if at least one of the reflected-wave electric power measurement values becomes higher than or equal to the protection electric power threshold value during execution of the temperature-based protection operation; and
the controller is configured to continue the electric power-based protection operation even if at least one of the temperature measurement values becomes higher than or equal to the protection temperature threshold value during execution of the electric power-based protection operation.

11. The radio wave emitting device according to claim 10, wherein:
the controller is configured to execute a temperature-based priority protection operation as the protection operation;
the temperature-based priority protection operation includes making each of the protection target values for the plurality of radio wave emitters lower than that in the temperature-based protection operation, or causing the plurality of radio wave emitters to stop emitting the plurality of radio waves; and
the controller is configured to switch the operation of the radio wave emitting device to the temperature-based priority protection operation if, during execution of the normal operation, the temperature-based protection operation, or the electric power-based protection operation, the controller determines that at least one of the temperature measurement values is higher than or equal to a priority protection temperature threshold value that is higher than the protection temperature threshold value.

12. The radio wave emitting device according to claim 10, wherein:
the controller is configured to execute an electric power-based priority protection operation;
the electric power-based priority protection operation includes making each of the protection target values for the plurality of radio wave emitters lower than that in the electric power-based protection operation, or causing the plurality of radio wave emitters to stop emitting the plurality of radio waves; and
the controller is configured to switch the operation of the radio wave emitting device to the electric power-based priority protection operation if, during execution of the normal operation, the temperature-based protection operation, or the electric power-based protection operation, the controller determines that at least one of the reflected-wave electric power measurement values is higher than or equal to a priority protection electric power threshold value that is higher than the protection electric power threshold value.

13. A radio wave emitting device comprising:
a cavity configured to accommodate an irradiation target;
one or more signal generators configured to generate one or more high frequency signals;
a signal amplifier configured to amplify the one or more high frequency signals and output a plurality of amplified high frequency signals;
a plurality of radio wave emitters configured to emit a plurality of radio waves into the cavity based on the plurality of amplified high frequency signals;
a plurality of measurers configured to output one or both of (i) temperature measurement values and (ii) reflected-wave electric power measurement values, the temperature measurement values each indicating a temperature of a corresponding one of the plurality of signal amplifiers, and the reflected-wave electric power measurement values each indicating an electric power of a reflected wave flowing back through a corresponding one of the plurality of radio wave emitters; and
a controller configured to control the one or more signal generators and the plurality of signal amplifiers; wherein:
the controller is configured to switch an operation of the radio wave emitting device from a normal operation to a protection operation when the controller determines, during execution of the normal operation, that protection is necessary for at least one of the plurality of signal amplifiers, based on one or both of the temperature measurement values and the reflected-wave power measurement values;
the normal operation includes setting electric power target values for the plurality of radio waves to respective normal target values for the plurality of radio wave emitters;
the protection operation includes setting the electric power target values for the plurality of radio waves to respective protection target values for the plurality of radio wave emitters;
for a plurality of radio wave emitters, a protection target value is lower than a normal target value; and
a ratio of the protection target values for the plurality of radio wave emitters is equal to a ratio of the normal target values for the plurality of radio wave emitters.
